(19) United States
(12) Patent Application Publication
(10) Pub. No.: US 2007/0234281 A1
(43) Pub. Date: Oct. 4, 2007

(54) Apparatus for analyzing task specification

(75) Inventors: Kota Inouchi, Tokyo (JP); Takashi Kashimoto, Kawasaki (JP); Kazuyuki Aoyama, Akishima (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/520,340

(22) Filed: Sep. 12, 2006

(30) Foreign Application Priority Data
Mar. 28, 2006 (JP) 2006-086862

(51) Int. Cl. G06F 9/44

(52) U.S. Cl. 717/104; 717/124

(57) ABSTRACT

When instructions involved in a switching of a task are extracted from a program under analysis, the result is that most instructions are involved in tasks. An instruction which forms part of a program under analysis is displayed together with a value which evaluates the possibility that the instruction is involved in a task. An apparatus for analyzing task specifications comprises a task specification analysis unit for determining whether an input set by an instruction is a constant or a data item depending on another instruction, and calculating a value indicative of the possibility of involvement in a task depending on the type of the instruction as a score, and a task specification analysis result display unit for displaying both the instruction and score, wherein corresponding instructions are displayed such that they can be identified by a specified range of the score.

### INCORPORATION BY REFERENCE

The present application claims priority from Japanese application JP2006-086862 filed on Mar. 28, 2006, the content of which is hereby incorporated by reference into this application.

### BACKGROUND OF THE INVENTION

The present invention relates to program analysis techniques for analyzing a program used in an information system and supporting extraction of instructions in the program associated with a change in task.

For recovering task specifications embedded in a program, it is necessary to identify, from a task view point, those parts which one wishes to utilize in the program. For this purpose, it is necessary to produce task specifications for the program. In doing so, however, the specifications must be created after reading and understanding an immense amount of source codes at present.

Thus, an attempt has been made to divide existing programs into sections related to tasks and sections related to control, and extract the section related to tasks, thereby efficiently understanding the contents of processing performed by the program.

A system described in Japanese Patent No. 3377836 describes a system which analyzes task specifications by dividing a program into sections related to tasks and sections related to control, as described above. This system relies on data items of a program to determine whether or not an instruction relates to a task or control. The determination method proceeds as follows on the assumption that an instruction relates to a task when it has data items that satisfy the following conditions:

“when even one data item is an input”; and

“when a data item is a variable, a search is made for an instruction which updates the data item, and that instruction has an input data item”

In other words, an instruction related to task specifications includes without fail a data item related to an input.

### SUMMARY OF THE INVENTION

The prior art technique relies only on input to determine whether an instruction of a program should be classified into a task or control in such a manner that an instruction having a data item related to an input is involved in a task, whereas an instruction having a data item not related to an input is involved in control.

However, when considering respective instructions in an actual program, a majority of data items included in the instructions relate to inputs. Accordingly, a majority of instructions in a program are classified into instructions related to tasks. The instructions classified into those related to tasks also include those instructions which include data items related to inputs but are not involved in task specifications.

As a result, since an operator must determine whether most of instructions in a program actually relate to tasks, the operator cannot efficiently understand which processing is performed in the program.

Accordingly, it is an object of the present invention to provide a system which supports a task specification analysis for presenting a user with instructions which can relate to task instructions in such a manner that the user can efficiently understand them.

To achieve the above object, the present invention gives priorities to instructions which are classified to be involved in a task as well in order to confirm an instruction which is more likely to be involved in a task.

A program under analysis is identified according to items, the possibility of involvement in a task is evaluated for a control dependence relationship between data items included in each of identified instructions of the program and instructions, the possibility that each instruction of the program is involved in task specifications is evaluated, and the instructions and values are displayed side by side on a display screen. In response to an indication of a value range from the operator, instructions which should be preferentially displayed (instructions highly likely to be involved in tasks) are selected. A display unit is provided for displaying those instructions which fall within the indicated value range in a visually emphasized manner.

Advantageously, the present invention can pick up instructions involved in task specifications from a program under analysis together with values which indicate the possibility of involvement, and display and provide instructions in accordance with a specified value range. Instructions required to confirm task specifications can be selectively identified, thus contributing to a higher efficiency in the development of a variety of systems.

The other objects and methods of achieving the objects will be readily understood in conjunction with the description of embodiments of the present invention and drawings.

### BRIEF DESCRIPTION OF THE DRAWINGS

FIG. 1 is a block diagram generally illustrating the configuration of a system according to one embodiment of the present invention;

FIG. 2 is a flow chart for describing functions of a control unit 109;

FIG. 3 is a flow chart for describing a task specification analysis function at step 202;

FIG. 4 is a flow chart for describing a process for setting initial values in task processing condition information tables at step 304;

FIG. 5 is a flow chart for describing a processing statement score calculation process at step 306;

FIG. 6 is a flow chart for describing a weighting coefficient calculation process at step 502;

FIG. 7 is a flow chart for describing a calculation unit score calculation process at step 504;

FIG. 8 is a flow chart for describing a data item score calculation process at step 708;

FIG. 9 is an ER (Entity-Relation) diagram showing associations among respective tables;

FIG. 10 is an instruction information table for registering a program under analysis on an instruction-by-instruction basis;

FIG. 11 is a data item information table for registering a program under analysis according to data items of individual instructions;

FIG. 12 shows a control dependency information table for managing an instruction number added to an instruction which is a dependence target or a dependence source in control dependence;

FIG. 13 shows a control dependency information table for managing a data item of an individual instruction, an instruction number added to an instruction which is a data dependence source of the data item, and an instruction number added to the instruction;

FIG. 14 shows a processing statement information table for registering a value indicative of the possibility of an instruction which is involved in a switching of a task on an instruction-by-instruction basis;

FIG. 15 shows a data item score table for registering a value indicative of the possibility of a data item which is involved in a switching of a task according to data items of individual instructions;

FIG. 16 shows a data item initial value score table for registering a value indicative of the possibility of a data item which is involved in a task when it is an input and when it is a constant;

FIG. 17 shows a processing content coefficient setting table for registering a value indicative of how much a control dependence target is less likely to be involved in a task as compared with a control dependence source;

FIG. 18 shows a loop error determination table for registering an erroneous state in which no weighting coefficient can be calculated in the weighting coefficient calculation process;

FIG. 19 shows a program under analysis used in an embodiment;

FIG. 20 shows an instruction information table before a task specification analysis function at step 202;

FIG. 21 shows a data item information table before the task specification analysis function at step 202;

FIG. 22 shows a control dependence information table before the task specification analysis function at step 202;

FIG. 23 shows a data dependence information table before the task specification analysis function at step 202;

FIG. 24 shows a loop error determination table before a process for setting initial values for task processing condition information tables at step 304;

FIG. 25 shows a processing content coefficient setting table before the process for setting initial values for task processing condition information tables at step 304;

FIG. 26 shows a data item initial value score setting table before the process for setting initial values for task processing condition information tables at step 304;

FIG. 27 shows a processing statement information table before a processing statement score calculation process at step 306;

FIG. 28 shows a data item score table before the processing statement score calculation process at step 306;

FIG. 29 shows the processing statement information table after the processing statement score calculation process at step 306;

FIG. 30 shows the data item score table after the processing statement score calculation process at step 306;

FIG. 31 shows a menu screen in use for describing functions of the control unit 109;

FIG. 32 shows a screen for accepting an initial value score entered from a user for a data item initial value score setting table, and a processed content coefficient for a processed content coefficient setting table;

FIG. 33 shows a screen for displaying task switching associated frequency information on an instruction-by-instruction basis;

FIG. 34 shows an exemplary task specification analysis result display screen;

FIG. 35 shows another example of a task-related program under analysis;

FIG. 36 shows a processing statement information table after a processed statement score calculation process of the task-related program in FIG. 35;

FIG. 37 shows a processing statement information table after the processing statement score calculation process for program line numbers “1” to “5”; and

FIG. 38 shows the processing statement information table after the processing statement score calculation process for program numbers “1” to “6”.

### DETAILED DESCRIPTION OF THE EMBODIMENTS

In the following, embodiments of the present invention will be described.

### <General Configuration>

In the following, embodiments of the present invention will be described in detail with reference to the accompanying drawings.

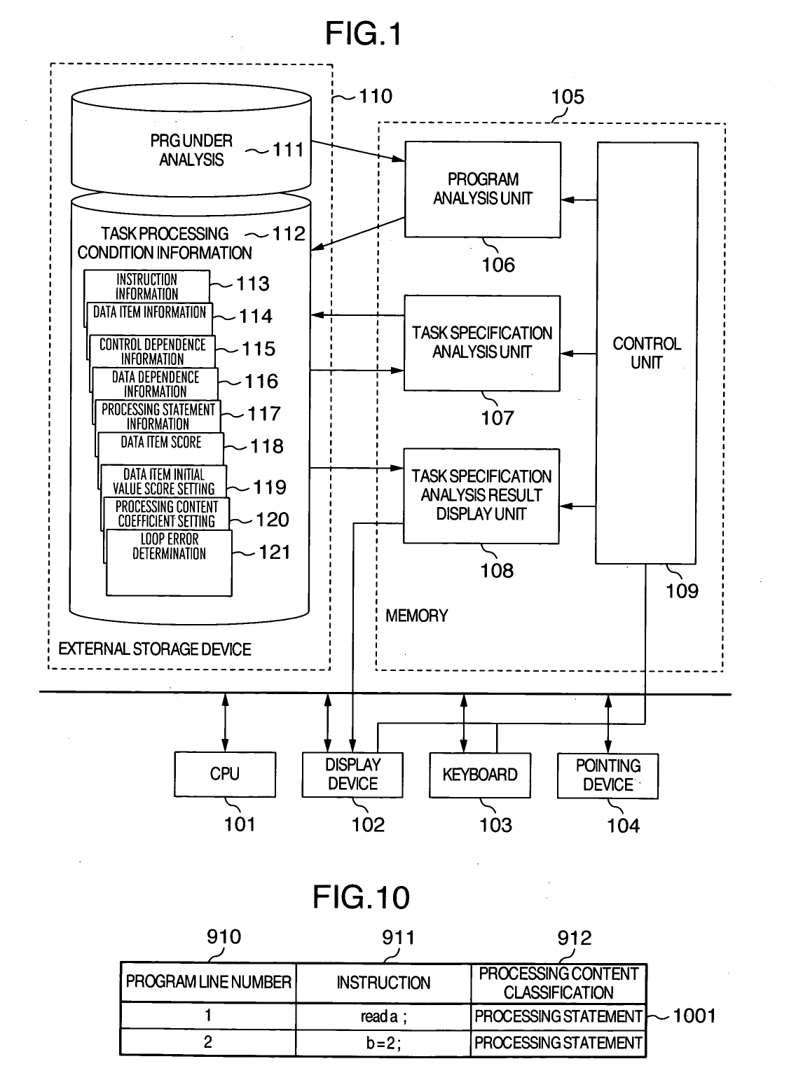

FIG. 1 generally illustrates the configuration of an apparatus for analyzing task specifications. A system comprises a CPU 101 connected through a connecting unit such as a bus; a display device 102; a keyboard 103; a pointing device 104 such as a mouse; a memory 105; and programs 106-109 stored in the memory 105. The CPU 101 reads and executes a program on the memory 105, where the CPU 101 accesses an external storage device 110 to read and write necessary data. 110 designates the external storage device, and 111 and 112 designate data stored in the external storage device 110. A target program (target PRG) 111 is a program intended by the system of the present invention for analysis.

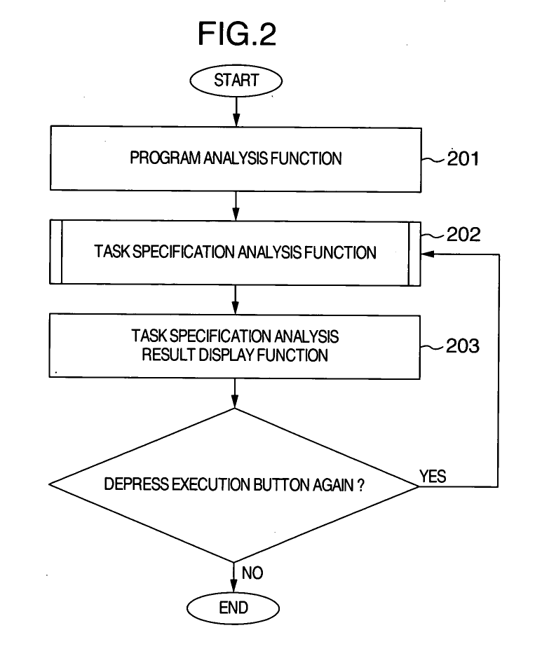

Functions of a control unit 109 in the apparatus for analyzing task specifications will be described with reference to a flow chart illustrated in FIG. 2. A function of the control unit 109 allows a user to specify a function from functions of a program analysis unit 106, a task specification analysis unit 107, and a task specification analysis result display unit 108, to execute a specified function.

The program analysis unit 106 searches for the program 111 under analysis using the name of a program specified by the user from an input device (103, 104) as a key to retrieve the program under analysis. Then, the program analysis unit 106 performs a process for providing task processing condition information 112 with program analysis result information which includes instruction information, data item information, control dependence information, and data dependence information (step 201).

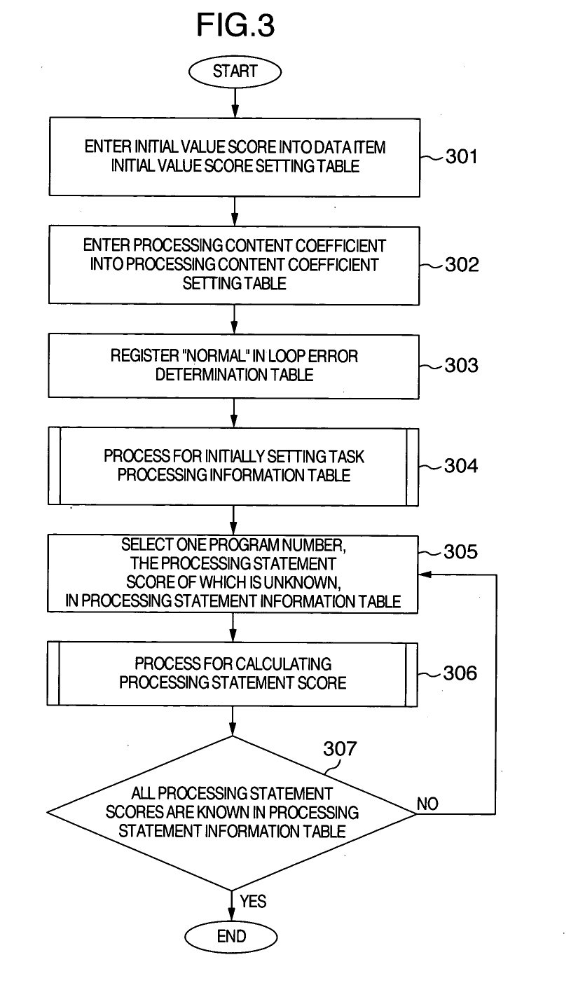

The task specification analysis unit 107 executes a process defined by a task specification analysis function 202 to provide the task processing condition information 112 with a task specification analysis result which includes a value indicative of the possibility that an instruction is involved in a switching of a task. The process defined by the task specification analysis function 202 will be described below in greater detail with reference to FIG. 3 (Step 202).

The task specification analysis result display unit 108 executes a task specification analysis result display function 203 to read out a task specification analysis result stored in the task processing condition information 112, and performs a process for displaying a correspondence of an instruction to a value indicative of the possibility that the instruction is involved in a switching of a task on a display device 102 (step 203).

The user is again prompted to select whether or not the task specification analysis function should be executed on the result of the task specification analysis displayed on the display device 102 (Step 204).

The foregoing steps (201-204) are repeatedly executed while the user again selects the execution of the task specification analysis function, and the operation of the apparatus (process in the control unit 109) terminates when the user selects the termination of the task specification analysis function.

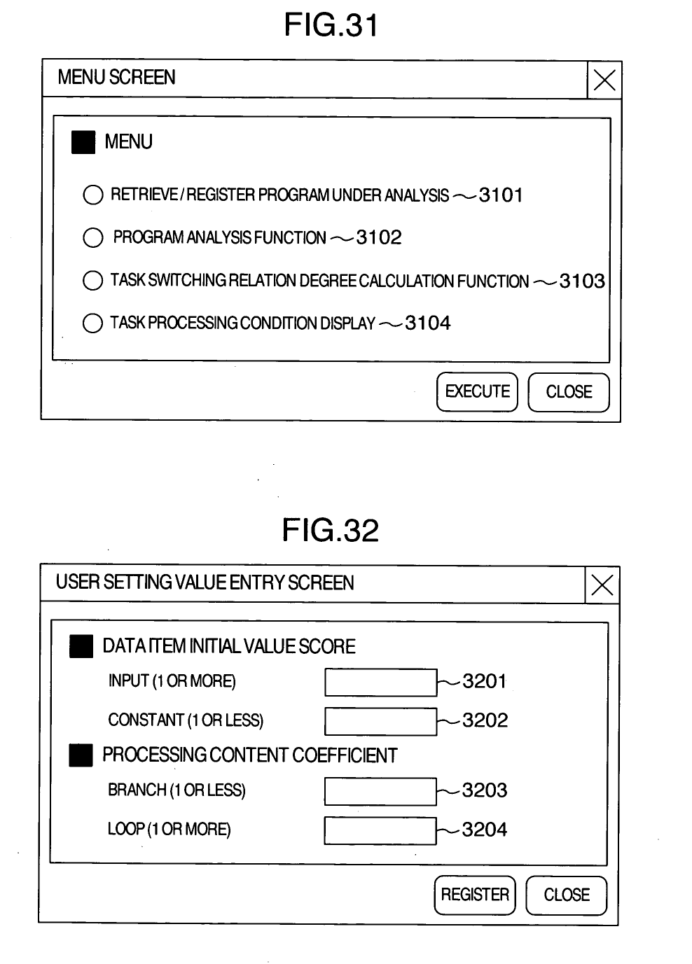

Next, functions of the control unit 109 will be described in a specific manner with reference to a menu screen of FIG. 31.

First, the menu screen of FIG. 31 is displayed on the display device 102. Upon acceptance of selection and execution of retrieval and registration of a program under analysis from the user (3101), the program under analysis is retrieved from the target PRG 111.

After the retrieval of the program under analysis, selection/execution of a program analysis function (3102) is accepted from the user, a program analysis result is created by a process of the program analysis unit 106, and the result is registered in the task processing condition information 112. An instruction information table 113, a data item information table 114, a control dependence information table 115, and a data dependence information table 116, into which data have been entered, are created from the created program analysis result. These tables will be described below in greater detail.

Next, the user is prompted to select the program analysis function 3102 to initiate the task specification analysis unit 107. On a user set value entry screen (FIG. 32) displayed by initiating the task specification analysis unit 107, several numerical settings are received from the user. In the program under analysis, a value indicative of the possibility that an input data item is involved in a switching of a task (hereinafter called the “input initial value score” is received in an entry field 3201; a value indicative of the possibility that a constant data item is involved in a switching of a task (hereinafter called the “constant initial value score”) is received in an entry field 3202; a value indicative of how much a control dependence target instruction is less likely to be involved in a switching of a task as compared with a control dependence source instruction when the processing contents of the control dependence source instruction is a branch process (hereinafter called the “processing contents coefficient of branch process”) is received in an entry field 3203; and a value indicative of how much a control dependence target instruction is less likely to be involved in a switching of a task as compared with a control dependence source instruction when processing contents of the control dependence source instruction is a loop process is received in an entry field 3204. However, an initial value score for an input is set to “1” or more in consideration of the existence of an instruction which is highly likely to be involved in a switching of a task, like a control statement which uses an input for a determination condition in an instruction which is deep in layer of a control dependence relationship. Also, an initial value score for a constant, a processing content coefficient for a branch process, and a processing content coefficient for a loop process are set to “1” or less in consideration of the fact that the possibility that a first instruction is involved in a switching of a task is lower than the possibility that a different second instruction, which is a control dependence source of the first instruction, is involved in the switching of the task, when the first instruction is a control statement which does not use an input for a determination condition.

As the user depresses a registration button on the user set value specification entry screen of FIG. 32, the task specification analysis unit 107 creates a task specification analysis result, and registers the result in the task processing condition information 112. The task specification analysis result refers to a processing statement information table 117, a data item score table 118, a data item initial value score table 119, a processing content coefficient setting table 120, and a loop error determination table 121. These tables will be described later in detail.

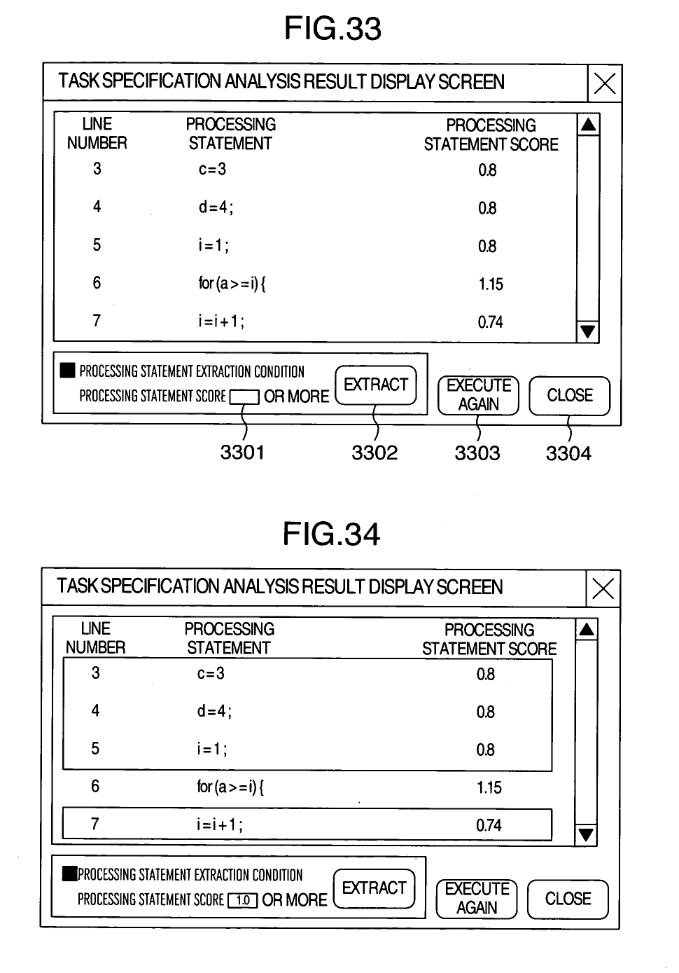

After the task specification analysis result has been created after the termination of the registration process on the setting value entry screen in FIG. 32, the menu screen of FIG. 31 is again displayed to receive the selection of a task specification analysis result display 3104 from the user. The task specification analysis result display unit 108 is then initiated to display the task specification analysis result on a task specification analysis result display screen of FIG. 33. As a result of displaying the task specification analysis result in FIG. 33, when one wants to explicitly display instructions equal to or more than a certain processing statement score, a value is specified in an entry field 3301, and an extraction button 3302 is depressed. The processing statement score represents the possibility that an instruction which performs the process is involved in a task in the form of a value. While a lower limit is zero, no upper limit is set, such that a larger value indicates a higher possibility that an instruction is involved in a task. For example, when the user explicitly displays instructions which have the processing statement score equal to or more than “1.0”, the user specifies “1.0” in the entry field 3301, and depresses the extraction button to produce a task specification analysis result display screen of FIG. 34.

Also, as a result of referencing the task specification analysis result display screen of FIG. 33, if the user requests to again execute the task specification analysis function, an input of an execute again button 3303 is accepted to again execute the task specification analysis function. When the task specification analysis function need not be executed, an input of an end button 3304 is accepted to terminate the apparatus for analyzing task specifications.

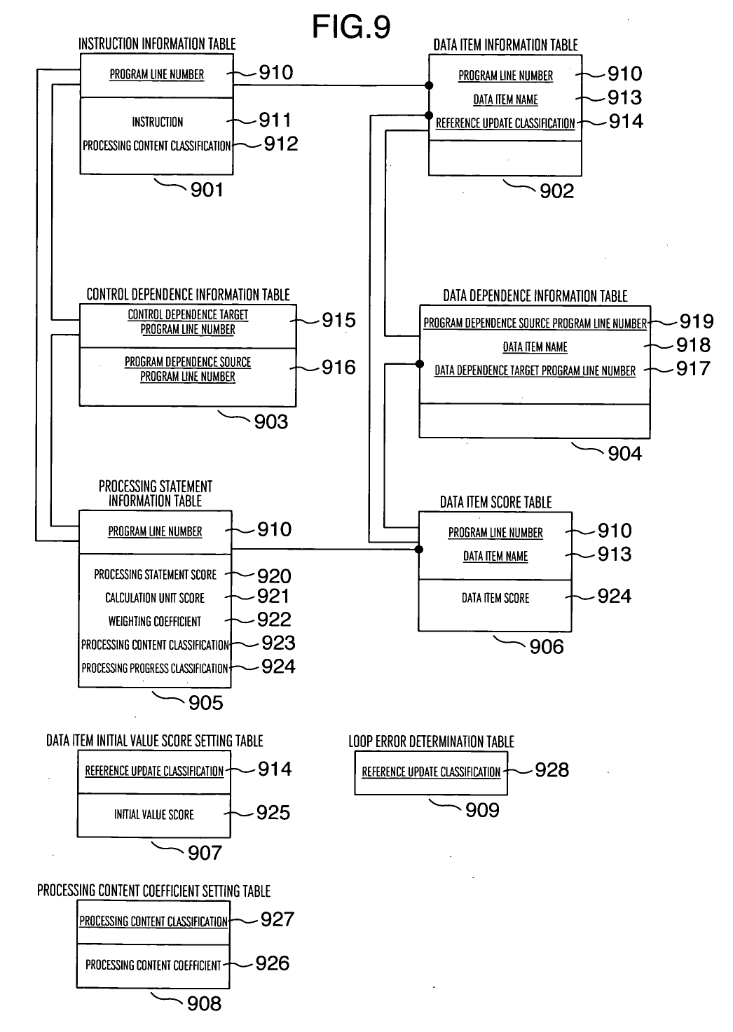

Next, a description will be made on the external storage device 110 of the apparatus for analyzing task specifications. The external storage device 110 stores the program under analysis 111 and the task processing control information 112. The target program 111 stores a program under analysis, and the task processing condition information 112 stores a instruction information table 901, a data item information table 902, a control dependence information table 903, a data dependence information table 904, a processing statement information table 905, a data item score table 906, a data item initial value score setting 1007, a processing content coefficient setting table 908, and a loop error determination table 908. Information in these tables is read by the control unit 109 for use in a process of the program analysis unit 106, a process in the task specification analysis unit 107, and a process in the task specification analysis result display unit 108. Lines interconnecting the respective tables in FIG. 9 represent associations among these tables.

In the following, these tables will be described in detail.

The instruction information table 901 registers a program line number 911 of a program under analysis, and a processing content classification 912 for identifying whether an instruction is a processing statement or a branch or an instruction or any other, which make up instruction information. In this connection, an exemplary data structure of the instruction table is shown in FIG. 10, later described.

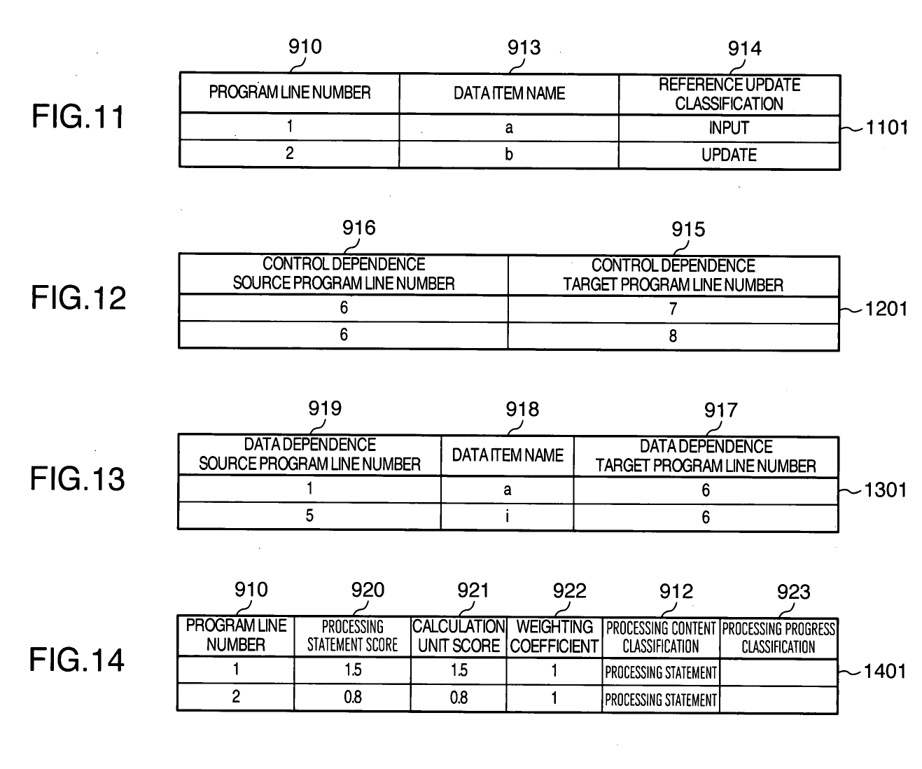

Data item information table 902 registers a program line number 910, a data item name 913 included in an individual instruction, and a reference update classification 914 for identifying whether a data item is a reference or an update or an input or a constant, which make up data item information. In this connection, an exemplary data structure of the data item information table 902 is shown in FIG. 11, later described.

The control dependence information table 903 registers a control dependence target program line number 915 indicative of a program line number of a first instruction in a program under analysis, and a control dependence source program line number 916 indicative of a program line number of a different second instruction which is a control dependence source of the first instruction, which make up control dependence information. An exemplary data structure of the control dependence information table 903 is shown in FIG. 12, later described.

The data dependence information table 904 registers a data dependence target program line number 917 indicative of a program line number of a first instruction in a program under analysis, a data item name 918 for each of data items included in the first instruction, and a data dependence source program line number 919 indicative of a program line number of an instruction of a data dependence source of each of the data items included in the first instruction, which make up data dependence information. An exemplary data structure of the data dependence information table 904 is shown in FIG. 13, later described.

The processing statement information table 905 registers a program line number 910; a processing statement score 920 which is a value indicative of the possibility that an instruction is involved in a switching of a task; a calculation u nit score 921 which is a value indicative of the possibility that a calculation unit of the instruction is involved in a switching of a task; a weighting coefficient 922 which is a value indicative of how much the instruction is less likely to be involved in a switching of a task as compared with another instruction of a control dependence source; a processing content classification 923, and processing progress classification 924 for distinguishing whether the instruction is being processed or not, which make up processing statement information. An exemplary data structure of the processing statement information table 905 is shown in FIG. 14, later described.

The data item score table 906 registers a program line number 910, a data item name 913, and a data item score 924 which is a value indicative of the possibility that a data item is involved in a switching of a task, which make up data item score information.

The data item initial value score setting table 907 registers a reference update classification 914; and an initial value score 925 which is a value indicative of the possibility that a data item name is involved in a switching of a task when its reference update classification is an input and a constant, which make up a data item initial value score.

The processing contents coefficient setting table 908 registers a processing content classification 926 for identifying whether the processing contents of an instruction are a branching process or a loop process; and a processing content coefficient 927 indicative of how much a certain first instruction is less likely to be involved in a task as compared with a different second instruction according to the processing contents of the second instruction which is a control source of the first instruction, which make up processing content coefficient settings.

The loop error determination table 909 registers a reference update classification 928 for identifying whether or not an error has occurred in a loop process, which makes up loop error determination information.

FIG. 10 shows exemplary contents of the instruction information table 901. 910 designates a program line number which is unique to each line of a program under analysis. Then, instruction information is uniquely identified by this program line number 910. An instruction 911 is a main statement of an instruction corresponding to a program line number. 912 designates a processing content classification for classifying the processing contents of an instruction corresponding to a program line number, and shows a branch when the instruction is performing a branching process, a loop when the instruction is performing a loop process, and a processing statement when the instruction includes a variable and is not a branch or a loop.

For example, instruction information 1001 indicates that a program line number of a program under analysis is “1”, an instruction is “read a;”, and the processing content classification is a “processing statement”.

FIG. 11 shows an example of the data item information table 902.

913 designates the name of a data item included in an instruction corresponding to a program line number. 914 designates a reference update classification for identifying a data item included in an instruction corresponding to a program line number, and stores “update” when the data item is a defined variable; “reference” when a referenced variable; “input” when a constant which is an input; and “constant” when a constant which is not an input. Then, data item information is uniquely identified by the program line number 910, data item name 913, and reference update classification 914, similar to those in FIG. 10. For example, data item information 1101 indicates that a program line number of a program under analysis is included in an instruction of “1”, and the reference update classification of the data item having the data item name “a” is “input”.

FIG. 12 shows an example of the control dependence information table 903.

915 designates a program line number of a first instruction in a program under analysis. Then, control dependence information is uniquely identified by this control dependence target program line number 915. 916 designates a program line number of a different second instruction which is a control dependence source of the first instruction.

For example, control dependence information 1201 indicates that the program line number of the control dependence source of an instruction having the program line number “7” of a program under analysis is “6”.

FIG. 13 shows an example of the data dependence information table 904.

917 designates a program line number of a first instruction in a program under analysis. 918 designates a data item name of each of data items included in the first instruction. 919 designates a program line number of an instruction of a data dependence target of each data item in the first instruction. Then, data dependence information is uniquely identified by these data dependence target program line number 917, data item name 918, and data dependence source program line number 919. For example, data dependence information 1301 indicates that the program line number of a data item dependence source of a data item having a data item name “a”, included in an instruction having a program line number “6” in a program under analysis is “1”.

FIG. 14 shows an example of the processing statement information table 905, where processing statement information is uniquely identified by the program line number 910 similar to that in FIG. 10. 920 designates a value indicative of the possibility that an instruction, the processing content classification of which is not NULL (i.e., a processing statement), is involved in a switching of a task in the instruction information table 901. The calculation unit score 921 is an average value of data item scores of a data item which references a value defined by another instruction, a data item which sets an input of the program with that instruction, and a data item which is a constant, included in each instruction. The weighting coefficient 922 is a value calculated from a product of a processing content coefficient indicative of how much a certain first instruction is less likely to be involved in a task as compared with a different second instruction for each processing content of the second instruction which is a control source of the first instruction, and a value indicative of the possibility that the second instruction is involved in a task. 912 designates a processing content classification for identifying a process of a processing statement, which is classified into one of a branch, a loop, and a processing statement. 923 designates a processing progress classification indicative of whether a certain processing statement is processing a calculation of a processing statement score or is not processing, and stores “processing under way” when a process is under way, and “NULL” (no value) when not.

For example, processing statement information 1401 indicates that an instruction having a program line number “1” of a program under analysis has a processing statement score of “1.5”, a calculation unit score of “1.5”, a weighting coefficient of “1”, a processing content classification of “processing statement”, and a processing progress classification of NULL (no value), in which case the processing statement information 1401 indicates that no score calculation is being processed for that program line.

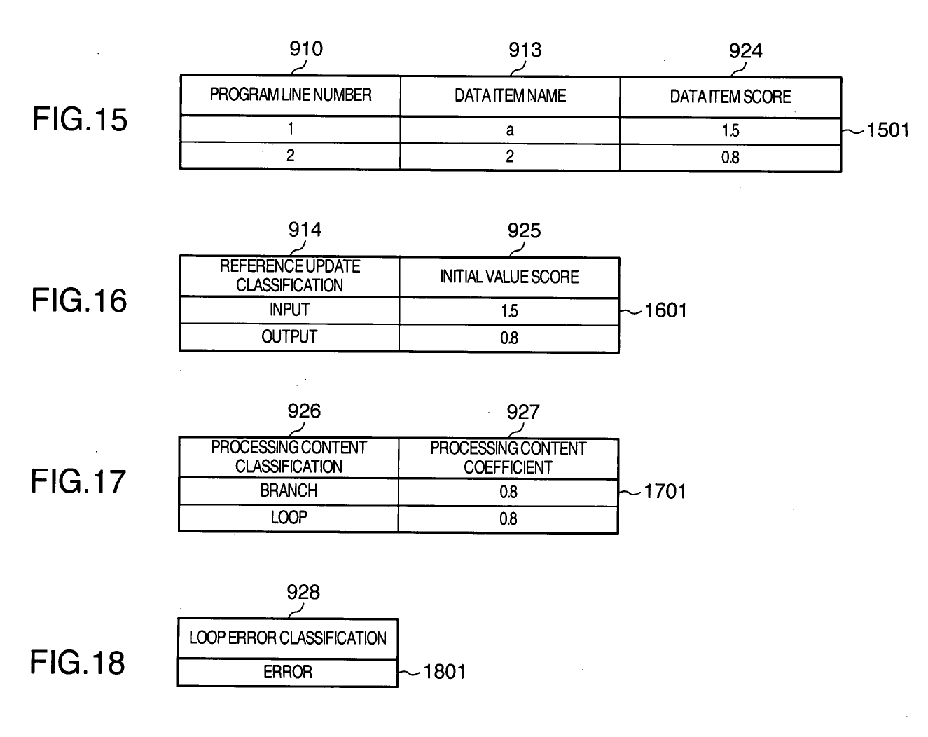

FIG. 15 shows an example of the data item score table 906, where a data item score is uniquely identified by the program line number 910 similar to that in FIG. 10, and the data item name 913 similar to that in FIG. 11. 924 designates a minimum value of processing statement scores of instructions of a plurality of data dependence sources in a data item of a certain first processing statement.

For example, data item score information 1501 indicates that a data item score of a data item, the data item name of which is “a”, included in an instruction having a program line number “1” under analysis is “1.5”.

FIG. 16 shows an example of the data item initial value score setting table 907. 914 designates a reference update classification of part of a reference update classification in FIG. 11, and is either an input or a constant. A data item initial value score is uniquely identified by this reference update classification 914. The initial value score 925 is a value indicative of the possibility that a data item is involved in a switching of a task when the data item is “input” or “constant”.

For example, a data item initial value score 1601 indicates that the value indicative of the possibility that a data item is involved in a switching of a task is “1.5” when the data item has a reference update classification of “input”.

FIG. 17 shows an example of the processing content coefficient setting table 908.

926 designates a processing content classification of part of the processing content classification in FIG. 10, and is either a branch or a loop. A processing content coefficient setting is uniquely identified by this processing content classification 926. The processing content coefficient 927 is a value indicative of a degree to which a certain first instruction of a control dependence target is affected by processing contents of a different second instruction of a control dependence source.

For example, a processing content coefficient setting 1701 indicates that the processing content coefficient is “0.8” when the processing content of a processing statement is “branch”.

FIG. 18 shows an example of the loop error determination table 909. 928 designates a loop error classification for determining whether or not an error is occurring in a process by a loop in a task specification analysis function, and is normal when no error is occurring, and erroneous when an error is occurring. A loop error determination table is uniquely identified by this loop error classification 928.

For example, a loop error determination 1801 indicates that an error is occurring in a loop in the task specification analysis function.

### <Program Analysis Process 1>

Referring next to FIGS. 2 to 8 and 19 to 30, processing operations of the apparatus for analyzing task specifications in this embodiment will be described in detail. First, a description will be made on a scenario in which required numerical information is fully available for acquiring a processing statement score indicative of the possibility associated with a task.

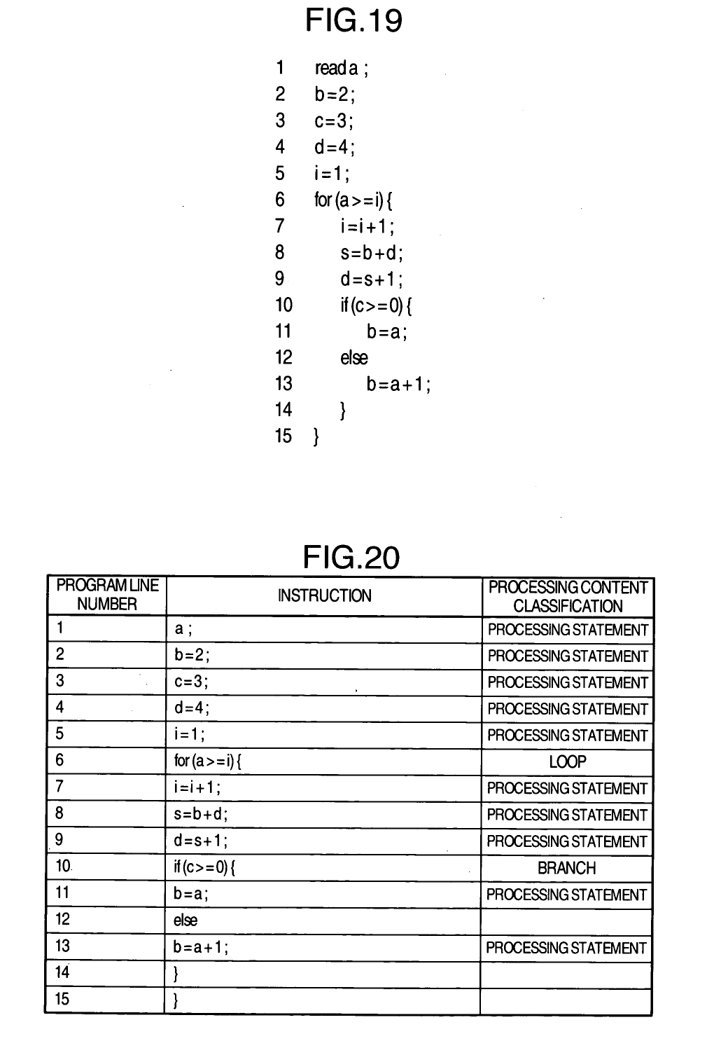

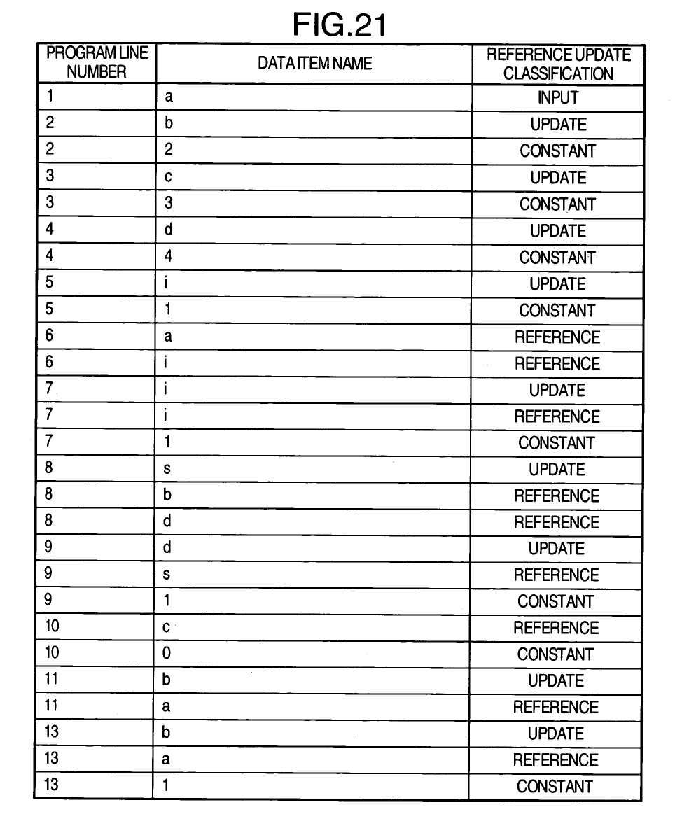

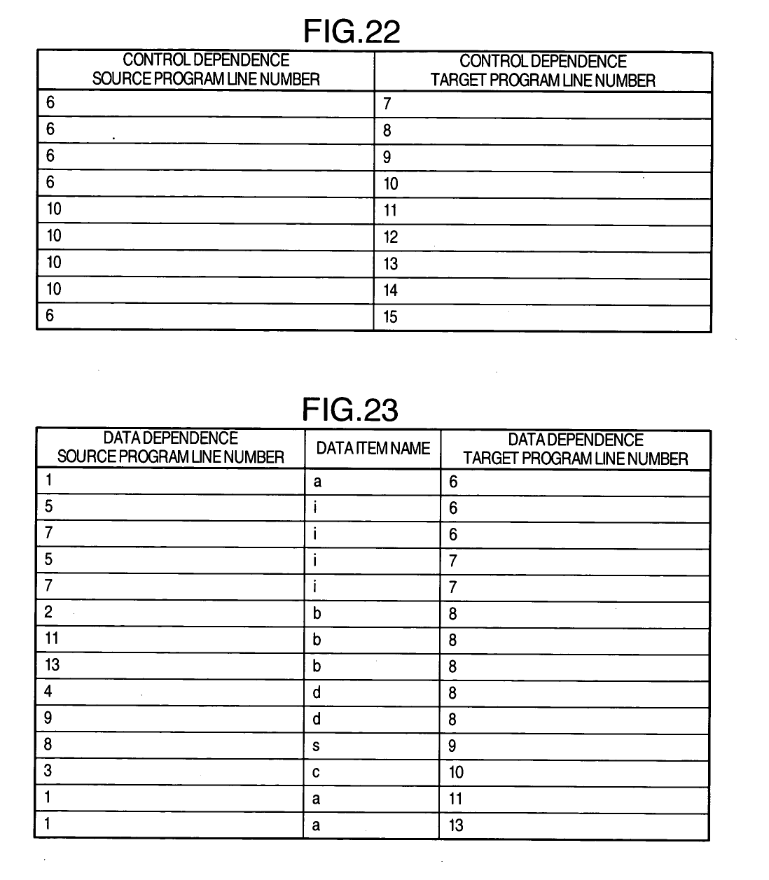

An operator initiates a program analysis function to select a program of FIG. 19 under analysis, and executes a program analysis to create an instruction information table of FIG. 20, a data item information table of FIG. 21, a control dependence information table of FIG. 22, and a data dependence information table of FIG. 23 (Step 201).

FIG. 3 illustrates a flow chart for describing a task specification analysis function 202. As the task specification analysis function 202 initiates in the task specification analysis unit 107, the operator is first prompted to enter initial values into a data item initial value score setting table at step 301. In this connection, the data item is data processed by a program under analysis, and no initial value score is set if it has been previously handled as data before a program line number on which the data appears. In the embodiment, as shown in FIG. 26, “1.5” is entered into an initial value score for a reference update classification which corresponds to an input, and “0.8” is entered into an initial value score for a reference update classification which corresponds to a constant (Step 301).

Next, at step 302, the operator is prompted to enter processing content coefficients into the processing content coefficient setting table. In the embodiment, as shown in FIG. 25, “0.8” is entered into a processing content coefficient for a processing content classification which corresponds to a branch, and “0.8” is entered into a processing content coefficient for a processing content classification which corresponds to a loop in the processing content coefficient setting table (Step 302).

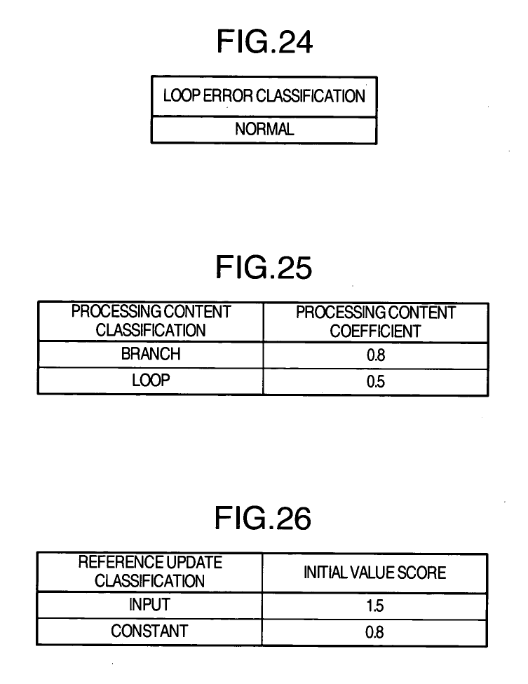

At next step 303, an initial value “normal” is registered in the loop error classification of the loop error determination table for analyzing the program from then on (Step 303 in FIG. 24).

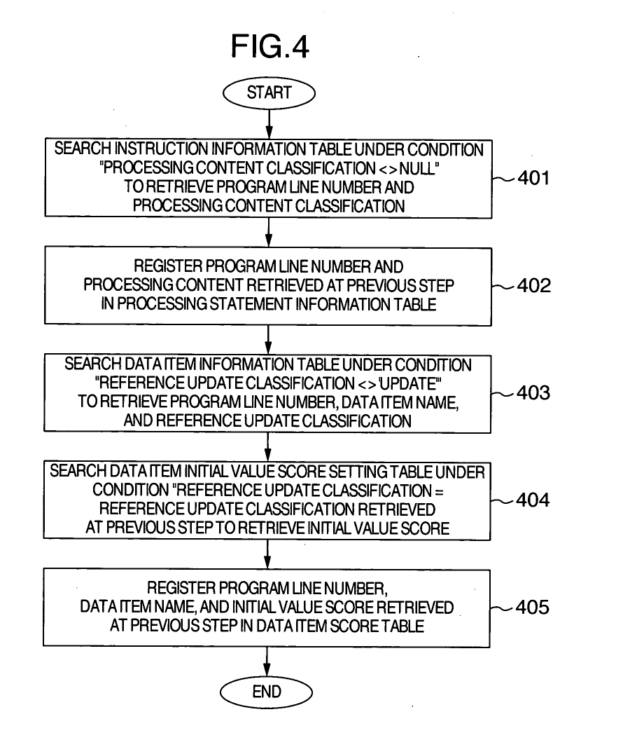

At step 304, an initial setting process is performed for task processing information tables. This process will be described with reference to FIG. 4.

At step 401, the instruction information table is searched under the condition “processing content classification <> NULL” to retrieve a program line number and a processing content classification. In the embodiment, the instruction information table is searched under the condition “processing content classification<>NULL” to retrieve a program line number and a processing content classification (Step 401).

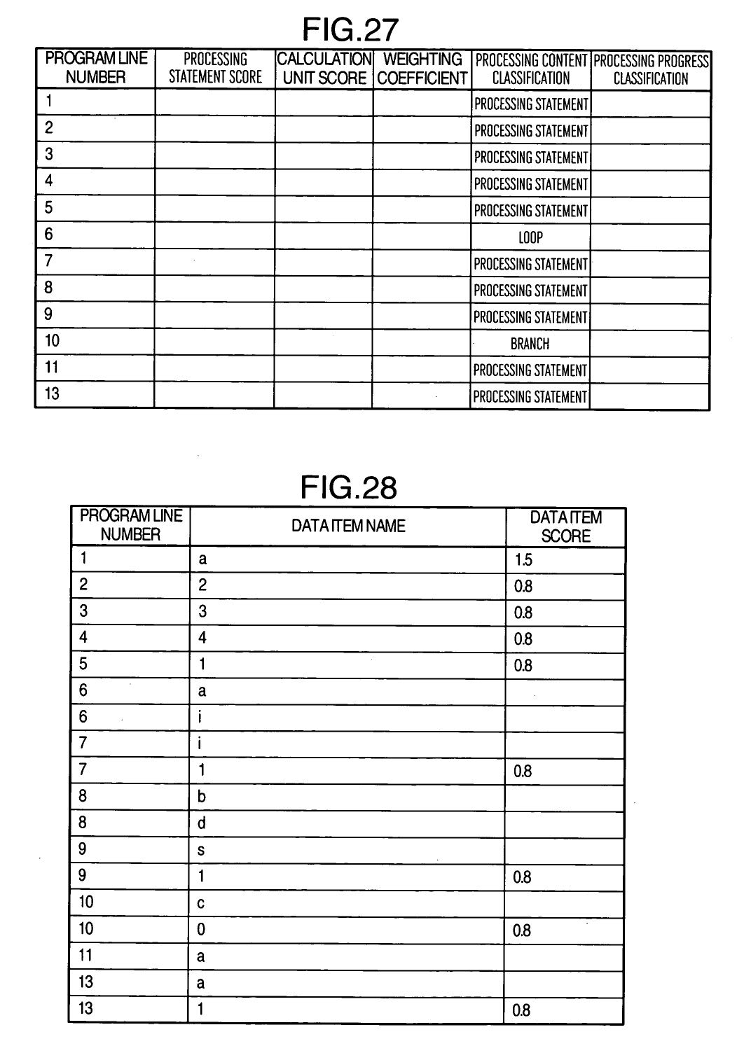

At step 402, the program line number and processing content, retrieved at the preceding step, are registered in the processing statement information table. In the embodiment, the program line number and processing content classification retrieved at step 401 are registered in the processing statement information table to create a processing statement information table of FIG. 27 (Step 402).

At step 403, the data item information table is searched under the condition “reference update classification<>‘update’” to retrieve a program line number, a data item name, and a reference update classification. In the embodiment, the data item information table of FIG. 21 is searched under the condition “reference update classification<>“update”” to retrieve a program line number, a data item name, and a reference update classification (Step 403).

At step 404, the data item initial value score setting table is searched under the condition “reference update classification=reference update classification retrieved at a previous step” to retrieve an initial value score. In the embodiment, the data item initial value score table of FIG. 26 is searched under the condition “reference update classification=reference update classification retrieved at step 403” to retrieve an initial value score (Step 404).

At step 405, the program line number, data item name, and initial value score retrieved at the preceding steps are registered in the data item score table. In the embodiment, the program line number retrieved at step 403, the data item name retrieved at step 403, and the initial value score retrieved at step 404 are registered in the data item score table to create a data item score table of FIG. 28 (Step 405).

At this time, a score is blank for a data item which is not set an initial value for the reference update classification at step 404. In this way, the initial value setting process (step 304 in FIG. 3) is performed for the task processing information tables.

Turning back to FIG. 3, the processing statement information table is in the state of FIG. 27 immediately after step 304. From then on, a processing statement score, a weighting coefficient, and a calculation unit score are found for each program line number shown in FIG. 27 (those instructions in the program under analysis which satisfy the condition “processing content classification<>NULL”).

At step 305, one program line number having an unknown processing statement score is selected in the processing statement information table. In FIG. 27 of the embodiment, program line number “1” is selected (Step 305).

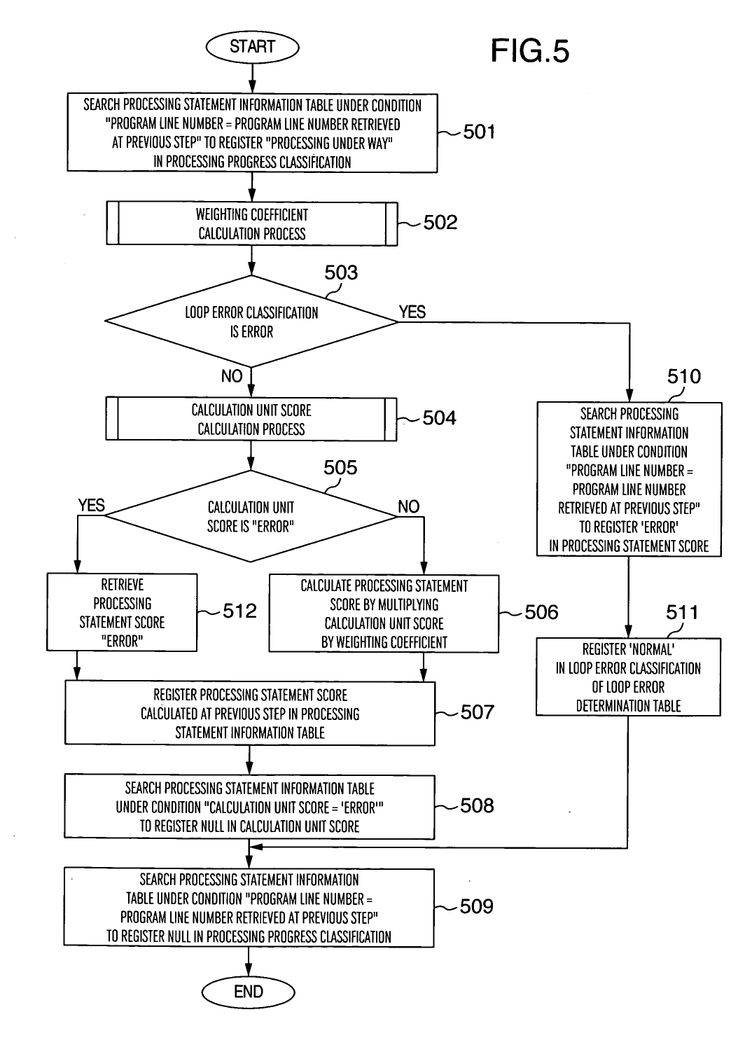

The next processing statement score calculation process (step 306) will be described in detail with reference to FIGS. 5 to 8.

At step 501, the processing statement information table is searched under the condition “program line number=program line number retrieved at a previous step” to register “processing under way” in the processing progress classification. In the embodiment, the processing statement information table of FIG. 27 is searched under the condition “program line number=program line number “1” retrieved at step 305” to register “processing under way” in the processing progress classification of program line number 1 (Step 501).

A weighting coefficient calculation process at next step 502 will be described with reference to the drawings.

At step 601, the control dependence information table of FIG. 22 is searched under the condition “control dependence target program line number=program line number” to retrieve a control dependence source program line number. In the embodiment, the control dependence information table is searched under the condition “control dependence target program line number=program line number “1” retrieved at step 305” to attempt to retrieve a control dependence source program line number, but no control dependence source program line number can be retrieved because there is not “1” stored in the control dependence target program line numbers in FIG. 22 (Step 601).

At step 602, it is determined whether or not the control dependence source program line number can be retrieved. In the embodiment, since no control dependence source program line number is available at step 601, No is determined (step 602), and a value “1” is chosen for the weighting coefficient at step 603.

At step 604, the processing statement information table is searched under the condition “program line number=program line number retrieved at a previous step” to register the weighting coefficient calculated at the preceding step. In the embodiment, the processing statement condition table is searched under the condition “program line number=program line number “1” retrieved at step 305” to register the value “1” chosen at step 603 in the weighting coefficient (Step 604).

At step 503, it is determined whether the loop error classification is “error” or others. In the embodiment, the loop error determination table of FIG. 24 is searched, and NO is de determined because the loop error determination classification is “normal” (Step 503).

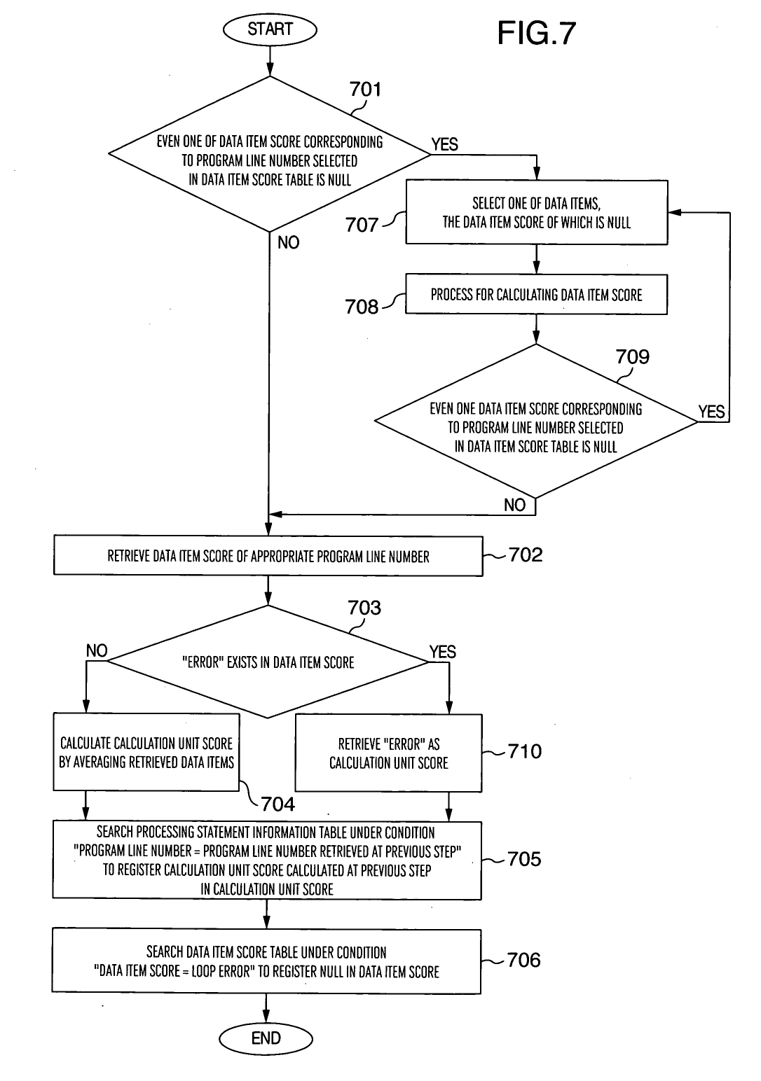

Next, a calculation unit score calculation process at step 504 will be described with reference to FIG. 7.

At step 701, in the data item score table of FIG. 28, it is determined whether or not there is even one NULL in the data scores corresponding to selected program line numbers. In the embodiment, NO is determined because the data item score corresponding to program line number “1” retrieved at step 305 is only “1.5” in the data item score table (Step 701).

At step 702, data item scores other than “error” are retrieved. In the embodiment, the data item score table of FIG. 28 is searched under the condition “program line number=program line number “1” retrieved at step 305” to retrieve data item score “1.5” (Step 702).

At step 703, it is determined whether or not “error” exists in the data item scores. In the embodiment, like step 702, NO is determined since only “1.5” has been retrieved, rather than error, for the data item score (Step 703).

At step 704, an average value is calculated for retrieved data item scores. In the embodiment, since the average value of data item score “1.5” retrieved at step 703 is calculated as a calculation unit score, “1.5” is calculated (Step 704).

At step 705, the processing statement information table is searched under the condition “program line number—program line number retrieved at a previous step” to register the calculation unit score calculated at the preceding step in the calculation unit score of the retrieved line number. In the embodiment, the processing statement information table of FIG. 27 is searched under the condition “program line number=program line number “1” retrieved at step 305” to register the value “1.5” retrieved at step 704 in the calculation unit score (Step 705).

At step 706, the data item score table is searched under the condition “data item score=loop error” to register NULL in the data item score. In the embodiment, the data item score table is searched under the condition “data item score=“error””, but no data item satisfies the condition (Step 706).

Consequently, the calculation unit score has been calculated at step 504.

At step 505, it is determined whether or not the calculation unit score is “error” in the processing statement information table. In the embodiment, NO is determined because there is no “error” existing in the calculation unit scores of the processing statement information table at this time (Step 505).

At step 506, a processing statement score is calculated by multiplying a calculation unit score by a weighting coefficient. In the embodiment, the processing statement score is calculated by multiplying the weighting coefficient “1” registered at step 604 by the calculation unit score “1.5” registered at step 705, thus resulting in the value “1.5” (Step 506).

At step 507, the processing statement score calculated at the preceding step is registered in the processing statement information table. In the embodiment, the processing statement information table of FIG. 27 is searched under the condition “program line number=program line number “1” retrieved at step 305” to register the value “1.5”, which has been retrieved at step 506, in the processing statement score of the program line number “1” (Step 507).

At step 508, the processing statement information table is searched under the condition “calculation unit score=‘error’” to register NULL in the calculation unit score. In the embodiment, the processing statement information table is searched under the condition “calculation unit score=“error””, no calculation unit score satisfies the condition (Step 508).

At step 509, the processing statement information table is searched under the condition “program line number=program line number retrieved at a previous step” to register NULL in the processing progress classification. In the embodiment, the processing statement information table is searched under the condition “program line number=program line number “1” retrieved at step 305”, but no program line number satisfies the condition (Step 509).

Through the foregoing procedure, the processing statement scores and weighting coefficients as shown in FIG. 27 are retrieved for registration in the processing statement information table.

At next step 307, it is determined whether or not all processing statement scores are known in the processing statement information table. In the embodiment, NO is determined because NULL still remains in the processing statement scores of the program line numbers “2” onward in the processing statement information table of FIG. 27 (Step 307).

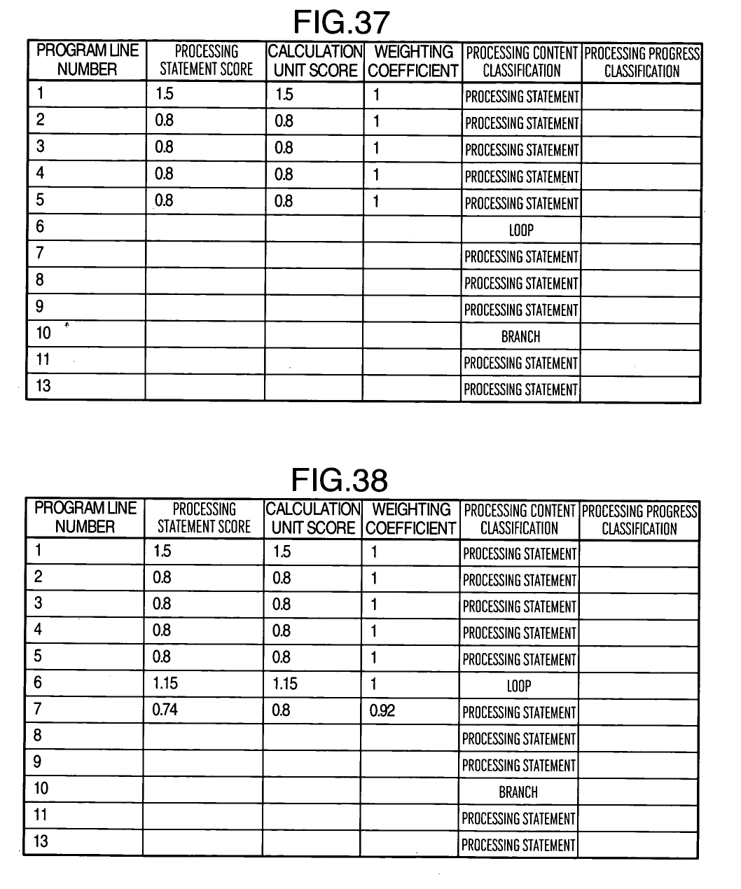

The processing statement scores of the program line numbers “2” to “5” in the processing statement information table are retrieved in a manner similar to the process performed for the program line number “1”. An intermediate state of the processing statement information table when the processing statement scores have been registered in the program line numbers “1” to “5” is as shown in FIG. 37. The processing statement score for the program line number “6” is retrieved by the following process.

### <Program Analysis Process 2>

Next, a description will be made on a scenario where numerical information required to retrieve processing statement scores has not been initially set for the data item scores.

First, in the processing statement information table (FIG. 37), a program line number “6”, the processing statement score of which is unknown is selected (Step 305).

The processing statement information table is searched under the condition “program line number=program line number “6” retrieved at step 305” to register “processing under way” in the processing progress classification (Step 501).

The weighting coefficient calculation process is performed in a manner similar to that performed with the program line number “1”. In this event, the weighting coefficient is “1”, so that “1” is registered in the weighting coefficient column of the program line number “6” in the processing statement information table (FIG. 37).

NO is determined because the loop error classification is “normal” in the loop error determination table of FIG. 24 (Step 503).

In the calculation unit score calculation process (504 in FIG. 5, FIG. 7), YES is determined because the data item scores corresponding to the program line number “6” retrieved at step 305 are “NULL” and “NULL” in the data item score table of FIG. 28 (Step 701).

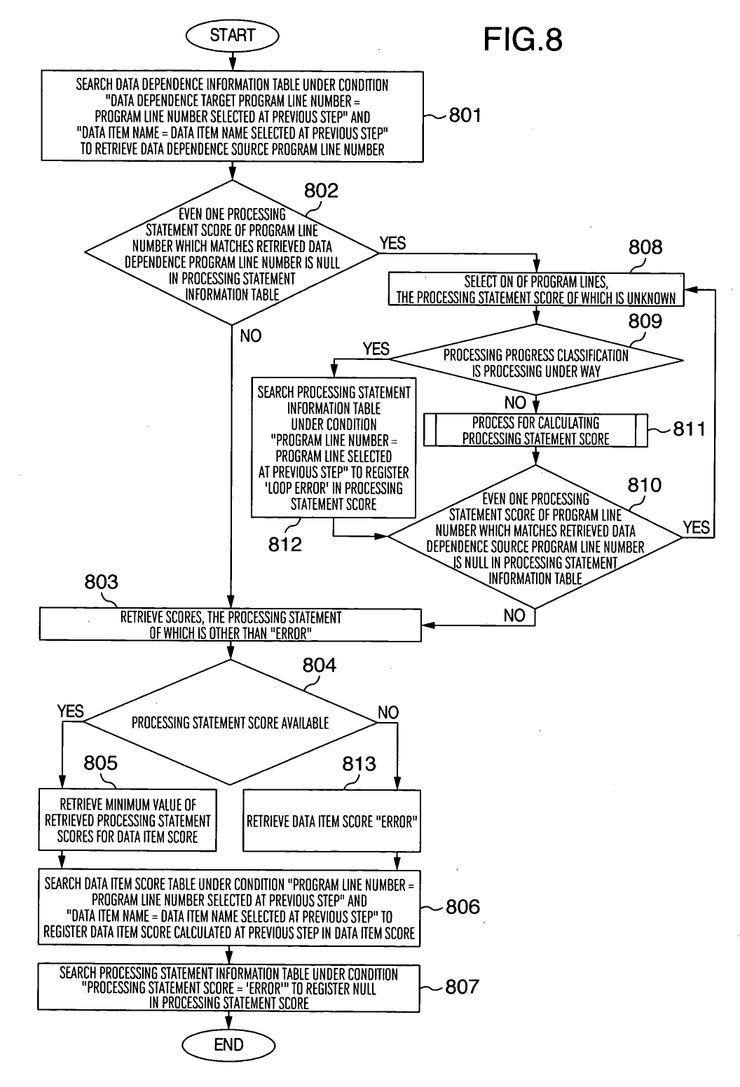

At step 707, one of data items, the data item score of which is NULL is selected. In the embodiment, the data item score table is searched under the condition that “program line number=program line number “6” retrieved at step 305” and “data item score=NULL” to retrieve data item names “a” and “i” which satisfy the search condition, then “a” is selected from them (step 707). For acquiring a data item score for the selected data item name “a”, a data item score calculation process (step 708 in FIG. 8) is performed.

At step 801, the data dependence information table of FIG. 23 is searched under the condition “data dependence target program line number=program line number selected at a previous step” and “data item name=data item name selected at a previous step” to retrieve a data dependence source program line number. In the embodiment, the data dependence information table of FIG. 23 is searched under the condition “data dependence target program line number—program line number “6” selected at step 305” and “data item name=data item name “a” selected at step 707” to retrieve a data dependence source program line number “1” (Step 801).

At step 802, it is determined whether or not NULL is stored even in one of processing statement scores of program line numbers which matches the retrieved data dependence source program line numbers in the processing statement information table. In the embodiment, NO is determined because the processing statement score of the program line number which matches the data dependence source program line number “1” retrieved at step 801 is “1.5” in the processing statement information table of FIG. 37 (Step 802).

At step 803, a score is retrieved except for those processing statement scores which are registered with “error”. In the embodiment, processing statement score “1.5” is selected because a processing statement score is selected other than processing statement scores registered with NULL from among processing statement scores of the program line number retrieved at step 801 (Step 803).

At step 804, it is determined whether or not the processing statement score is available. In the embodiment, since the processing statement score “1.5” has been selected at step 803, YES is determined (Step 803).

At step 805, a minimum value of found processing statement scores is selected for a data item score. In the embodiment, the data item score “1.5” is selected because a minimum value is selected for the data item score from among the processing statement scores retrieved at step 803 (Step 805).

At step 806, the data item score table is searched under the condition “program line number=program line number selected at a previous step” and “data item name=data item name selected at a previous step” to register a data item score calculated at a previous step in the data item score. In the embodiment, the data item score table of FIG. 28 is searched under the condition “program line number=program line number “6” selected at step 305” and “data item=data item name “a” selected at step 707” to register the data item score “1.5” selected at step 805 in the data item score (Step 806).

At step 807, the processing statement information table is searched under the condition “processing statement score=‘error’ ” to register NULL in the processing statement score. In the embodiment, the processing statement information table is searched under the condition “processing statement score=“error””, but no processing statement score satisfies the search condition (Step 807).

At step 709, it is determined whether or not NULL is stored even in one of data item scores corresponding to selected program line numbers in the data item score table. Specifically, this is a determination in order to perform a retrieval process if there still remains any data item score of NULL. In the embodiment, YES is determined because the data item scores corresponding to the program line number “6” retrieved at step 305 are “1.5” and “NULL” in the data item score table of FIG. 28 (Step 709).

The data item score table is searched under the condition “program line number=program line number “6” retrieved at step 305” and “data item score=“NULL”” to select a data item name “i” which satisfies the search condition (Step 707).

The data dependence information table of FIG. 23 is searched under the condition “data dependence target program line number=program line number “6” selected at step 305” and “data item name=data item name “i” selected at step 707” to retrieve data dependence source program line numbers “5” and “7” (Step 801).

YES is determined (step 802) because the processing statement scores of the program line numbers which matches the data dependence source program line numbers “5” and “7” retrieved at step 801 are “0.8” and NULL in the processing statement information table of FIG. 37.

At step 808, one of program line numbers, the processing statement score of which is unknown is selected. Here, program line number “7” has been selected. Next, a search is made in the processing statement information table (FIG. 37) under the condition that “processing statement score=data dependence source program line number “7” retrieved at step 801” and “processing statement score=NULL” to select one program line number “7” which satisfies the condition (step 808).

At step 809, it is determined whether the processing progress classification is “processing under way” or “not under way”. In the embodiment, NO is determined because the processing progress classification of the program line number “7” retrieved at step 808 is not “processing under way” (step 809). Then, a process is performed for previously calculating the processing statement score of the program line number “7” which is the dependence source of the program line number “6” (step 811). The calculation of the processing statement score is made by step 305 in FIG. 3, i.e., the process of FIG. 5.

The processing statement information table (FIG. 37) is searched under the condition “program line number=program line number “7” selected at step 808” to register “processing under way” in the processing progress classification (Step 501).

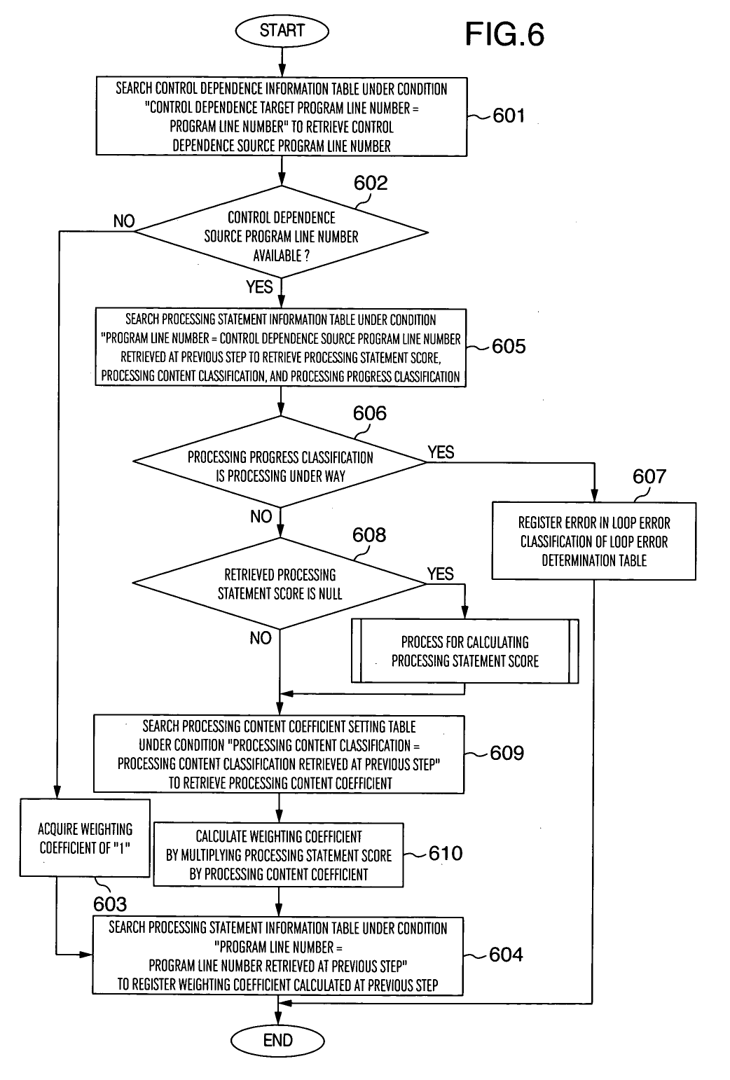

Next, a weighting coefficient is calculated for the program line number “7” at step 502 (FIG. 6).

The control dependence information table (FIG. 22) is searched under the condition “control dependence target program line number=program line number “7” retrieved at step 808” to retrieve the control dependence source program line number “6” (Step 601).

The system determines YES because the control dependence source program line number “6” has been retrieved at step 601 (Step 602).

At step 605, the processing statement information table is searched under the condition “program line number=control dependence source program line number retrieved at a previous step” to retrieve the processing statement score, processing content classification, and processing progress classification. In the embodiment, the processing statement information table is searched under the condition “program line number=line number “6” retrieved at step 601” to retrieve the processing statement score NULL, processing content classification “loop”, and the processing progress classification “processing under way” (Step 605).

At step 605, it is determined whether the processing progress classification is “processing under way” or “not under way”. In the embodiment, YES is determined because the processing progress classification retrieved at step 605 is “processing under way” (Step 606).

At step 607, “error” is registered in the loop error classification in the loop error determination table. In the embodiment, “error” is registered in the loop error classification of the loop error determination table (FIG. 24) (step 607). By now, step 502 in FIG. 5 is completed.

Turning back to step 503 in FIG. 5, YES is determined because the loop error classification (FIG. 24) in the loop error determination table is “error” (step 503).

At step 510, the processing statement information table is searched under the condition “program line number=program line number retrieved at a previous step” to register ‘error’ in the processing statement score. In the embodiment, the processing statement information table (FIG. 37) is searched under the condition “program line number=program line number “7” retrieved at step 808” to register “error” in the processing statement score (Step 510).

At step 511, ‘normal’ is registered in the loop error classification of the loop error determination table. In the embodiment, “normal” is registered in the loop error classification of the loop error determination table (Step 511).

The processing statement information table is searched under the condition “program line number=program line number “7” retrieved at step 808” to register NULL in the processing progress classification. (Step 509). By now, the calculation of the processing statement score (step 811) of the program line number “7” is completed for the calculation of the data item score (FIG. 28) of the program line number “6”.

Turning back to FIG. 8, it is determined at step 810 whether or not NULL is stored in even one of processing statement scores of program line numbers which matches the retrieved data dependence source program line number in the processing statement information table. In the embodiment, NO is determined because the processing statement scores of the program line numbers which matches the data dependence source program line numbers “5” and “7” retrieved at step 701 are “0.8” and “error” (Step 810).

The processing statement score “0.8” is selected from among the processing statement scores retrieved at step 801 in order to retrieve the processing statement, the processing statement score of which is other than “error” (Step 803).

Since the processing statement score “0.8” has been selected, YES is determined (Step 804).

The data item score “0.8” is selected because a minimum value is selected for the data item score from among the processing statement scores retrieved at step 803 (Step 805).

The data item score table is searched under the condition “program line number program line number “6” selected at step 305” and “data item=data item name “i” selected at step 707” to register the data item score “0.8” selected at step 805 in the data item score (Step 806).

The processing statement information table (FIG. 37) is searched under the condition “processing statement score=“error”” to register NULL in the processing statement score of the program line number “7” which satisfies the search condition at this time. (Step 807). By now, step 708 in FIG. 7 (data item calculation process in FIG. 8) is completed.

Turning back to step 709 in FIG. 7, NO is determined because the data item scores corresponding to the program line number “6” retrieved at step 305 are “1.5” and “0.8” in the data item score table (FIG. 28) (Step 709).

The data item score table is searched under the condition “program line number=program line number “6” retrieved at step 305” and “data item score<>“error”” to retrieve the data item scores “1.5” and “0.8” (Step 702).

NO is determined since there is no error (step 703).

“1.15” is picked up for calculating an average value of the data item scores “1.5” and “0.8” retrieved at step 702 as a calculation unit score (Step 704).

The processing statement information table (FIG. 37) is searched under the condition “program line number=program line number “6” retrieved at step 305” to register the value “1.15” picked up at step 704 in the calculation unit score (Step 705).

The data item score table (FIG. 28) is searched under the condition “data item score=“error””, but no data item satisfies the condition (step 706). By now, the calculation unit score calculation process 504 in FIG. 5 is completed.

In regard to step 505 to step 509, they are performed in a manner similar to the program line number “1”.

Now, the processing statement score calculation process in FIG. 3 is completed, followed by step 307 in FIG. 3.

NO is determined (step 307) because the processing statement scores are “NULL” for the program line numbers “7” onward in the processing table information table (FIG. 37), followed by returning to step 305.

Program line number “7”, the processing statement score of which is unknown is selected in the processing statement information table (FIG. 37) (Step 305).

The processing statement score calculation process 306 is performed in accordance with FIG. 5 in a similar manner as the aforementioned.

The processing statement information table (FIG. 37) is searched under the condition “program line number=program line number “7” selected at step 305” to register “processing under way” in the processing progress classification (Step 501).

The control dependence information table (FIG. 22) is searched under the condition “control dependence target program row number=program line number “7” retrieved at step 305” to retrieve the control dependence source program line number “6” (Step 601).

YES is determined because the control dependence source program line number “6” has been retrieved at step 601 (Step 602).

The processing statement information table is searched under the condition “program line number=line number “6” retrieved at step 601” to retrieve the processing statement score “1.15”, the processing content classification “loop”, and the processing progress classification NULL (Step 605).

NO is determined because the processing progress classification retrieved at step 605 is NULL (Step 606).

At step 608, it is determined whether or not the retrieved processing statement score is NULL. In the embodiment, NO is determined because the processing statement score retrieved at step 605 is “1.15” (Step 608).

At step 609, the processing content coefficient setting table is searched under the condition “processing content classification=processing content classification retrieved at a previous step” to retrieve a processing content coefficient. In the embodiment, the processing content coefficient setting tale is searched under the condition “processing content classification=processing content classification “loop” retrieved at step 605” to retrieve a processing content coefficient “0.8” (Step 609).

At step 610, a weighting coefficient is calculated by multiplying the processing statement score by the processing content coefficient. In the embodiment, the weighting coefficient is calculated to be “0.92” because the processing statement score “1.15” retrieved at step 605 is multiplied by the processing content coefficient “0.8” retrieved at step 609 (Step 610).

The processing statement condition table is searched under the condition “program line number=program line number “7” retrieved at step 305” to register the calculated value “0.92” in the weighting coefficient (Step 604).

The process from step 504 to step 509 for the program line number “7” is performed in a similar manner to the program line number “6”. At this stage (the process has been completed up to the program line number “7”), the processing statement information table is in a state shown in FIG. 38.

### <Program Analysis Process 3>

Another example will be described for a scenario where no initial value is set in the data item score.

NO is determined because the processing statement score is “NULL” for the program line numbers “8” onward in the processing statement information table (Step 307).

A program line number “8”, the processing state score of which is unknown is selected in the processing statement information table (FIG. 38) (Step 305).

The processing statement information table is searched under the condition “program line number=program line number “8” retrieved at step 305” to register “processing under way” in the processing progress classification (Step 501).

The weighting coefficient calculation process (step 502) for the program line number “8” is performed in a similar manner to the program line number “7”. This results in a weighting coefficient of 0.92. NO is determined because the loop error classification is “normal” in the loop error determination table (Step 503).

A transition is made to next step 504 (calculation of the calculation unit score in FIG. 7).

YES is determined (step 701) because the data item scores corresponding to the program line number “8” retrieved at step 305 are “NULL” and “NULL” in the data item score table.

The data item score table is searched under the condition “program line number=program line number “8” retrieved at step 305” and “data item score=“NULL”” to select a data item name “b” which satisfies the search condition (step 707).

A transition is made to next step 708 (calculation of data item score in FIG. 8).

The data dependence information table of FIG. 23 is searched under the condition “data dependence target program line number=program line number “8” selected at step 305” and “data item name=data item name “b” selected at step 707” to retrieve data dependence source program line numbers “2”, “11” and “13” (step 801).

YES is determined (step 802) because the processing statement scores of the program line numbers which matches the data dependence source program line numbers “1”, “11” and “13” retrieved at step 801 are “1.5”, NULL and NULL in the processing statement information table.

In the processing statement information table (FIG. 38), a search is made under the condition “program line number=data dependence source program line number “8” retrieved at step 801” and “processing statement score=NULL” to select one program line number “11” which satisfies the condition (step 808).

NO is determined (step 809) because the processing progress classification of the program line number “11” selected at step 808 is not “processing under way” in the processing statement information table.

The calculation of the processing statement score (FIG. 22) at next step 811 is performed in accordance with FIG. 5.

The processing statement information table is searched under the condition “program line number=program line number “11” selected at step 808” to register “processing under way” in the processing progress classification (step 501).

The calculation of a weighting coefficient at next step 502 is performed in accordance with FIG. 6.

The control dependence information table is searched under the condition “control dependence target program line number=program line number “11” selected at step 808” to retrieve a control dependence source program line number “10” (step 601).

YES is determined (step 602) because the program dependence source program line number “10” has been retrieved at step 601.

The processing statement information table (FIG. 38) is searched under the condition “program line number=line number “10” selected at step 601” to retrieve the processing statement score NULL, the processing content classification “branch”, and the processing progress classification NULL (step 605).

NO is determined (step 606) because the processing progress classification retrieved at step 605 is NULL.

YES is determined (step 608) because the processing statement score retrieved at step 605 is NULL, followed by a process for calculating the processing statement score for the program line number “10”, where this calculation process is performed in accordance with the process of FIG. 5 in a manner similar to the program line number 6.

The process for calculating the processing statement score for a program line number 11 at step 609 onward is performed in a manner similar to the program line number 7. The processing at step 811 is completed, followed by a transition to step 810.

YES is determined (step 810) because the processing statement scores of program line numbers which match the data dependence source program line numbers “1”, “11” and “13” retrieved at step 801 are “1.5”, “0.55” and NULL in the processing statement information table (FIG. 38).

In the processing statement information table, a search is made under the condition “program line number=data dependence source program line number “8” retrieved at step 801” and “processing statement score=NULL” to select one program line number “13” which satisfies the condition (step 808).

NO is determined (step 809) because the processing progress classification of the program line number “13” retrieved at step 808 is not “processing under way” in the processing statement information table.

The process for calculating the processing statement score for the program number “13” is performed in a similar manner to the process for calculating the processing statement score for the program line number “11”.

NO is determined (step 810) because the processing statement scores of the program line numbers which match the data dependence source program line numbers “1”, “11” and “13” retrieved at step 801 are “1.5”, “0.55” and “0.42” in the processing statement information table.

The processing statement scores “1.5”, “0.55” and “0.42” are selected because processing statements, the processing statement score of which is other than “error”, are selected from among the processing statement scores selected at step 810 (step 803).

YES is determined (step 804) because the processing statement scores “1.5”, “0.55” and “0.42” have been selected.

The data item score “0.42” is picked up (step 805) because a minimum value of the processing statement scores selected at step 803 is designated to be a data item score.

The data item score tale is searched under the condition “program line number=program line number “8” selected at step 305” and “data item name=data item name “b” selected at step 707” to register the data item score “0.42” picked up at step 805 in the data item score (step 806).

The processing information table is searched under the condition “processing statement score=“error””, but no processing statement score satisfies the condition (step 807).

YES is determined (step 709) because the data item scores corresponding to the program line number “8” retrieved at step 305 are “0.42” and “NULL” in the data item score table.

The data item score table is searched under the condition “program line number=program line number “8” retrieved at step 305” and “data item score=“NULL”” to select a data item name “d” which satisfies the search condition (step 707).

The data dependence information table is searched under the condition “data dependence target program line number=program line number “8” selected at step 305” and “data item name=data item name “b” selected at step 707” to retrieve data dependence source program line numbers “4” and “9” (step 801).

YES is determined (step 802) because the processing statement scores of the program line numbers which match the data dependence source program line numbers “4” and “9” retrieved at step 801 are “0.8” and “NULL” in the processing statement information table.

A search is made in the processing statement information table under the condition “program line number=data dependence source program line number retrieved at step 801” and “processing statement score=NULL” to select one program line number “9” which satisfies the condition (step 808).

NO is determined (step 809) because the processing progress classification of the program line number “9” retrieved at step 808 is not “processing under way” in the processing statement information table (step 809).

Next step 501 (calculation of processing statement score) is performed in accordance with FIG. 5.

The processing statement information table is searched under the condition “program line number=program line number “9” retrieved at step 808” to register “processing under way” in the processing progress classification (step 501).

The calculation of a weighting coefficient at step 502 for the program line number “9” is performed in accordance with FIG. 6 in a manner similar to the program line number “7”.

A transition is made to next step 503, where NO is determined because the loop error classification in the loop error determination table is “normal” (step 503).

Next step 504 (process for calculating the calculation unit) is performed in accordance with FIG. 7.

YES is determined (step 701) because the data item scores corresponding to the program line number “8” retrieved at step 808 are NULL and “0.8” in the data item score table.

The data item score table is searched under the condition “program line number=program line number “9” retrieved at step 808” and “data item score “NULL” to select a data item name “s” which satisfies the search condition (Step 707).

The next process for calculating the data item score (step 708) is performed in accordance with FIG. 8.

The data item score table is searched under the condition “program line number=program line number “9” retrieved at step 707” and “data item name=data item name “s” selected at step 707” to retrieve data dependence source program line number “8” (Step 801).

YES is determined because the processing statement score of the program line number which matches the data dependence source program line number “8” retrieved at step 801 is NULL in the processing statement information table (step 802).

A search is made in the processing statement information table under the condition “program line number=data dependence source program line number retrieved at step 801” and “processing statement score=NULL” to select one program line number “8” which satisfies the condition (Step 808).

YES is determined (step 809) because the processing progress classification of the program line number “8” retrieved at step 808 is “processing under way” in the processing statement information table.

At step 812, the processing statement information table is searched under the condition “program line number=program line selected at a previous step” to register “loop error” in the processing statement score. In the embodiment, the processing statement information table is searched under the condition “program line number=program line number 8 selected at step 801” to register “error” in the processing statement score (step 812).

NO is determined (step 810) because the processing statement score of the program line number which matches the data dependence source program line number “8” retrieved at step 801 is “error” in the processing statement information table.

No processing statement score can be selected because processing statements, the processing statement score of which is other than “error”, are selected from among the processing statement scores selected at step 810 (step 803).

NO is determined (step 804) because no processing statement score can be retrieved at step 803.

At step 813, a data item score “error” is retrieved (step 813).

The data item score table is searched under the condition “program line number=program line number “9” selected at step 808” and “data item name=data item name “s” selected at step 707” to register the data item score “error” retrieved at step 813 in the data item score (step 806).

The processing statement information table is searched under the condition “processing statement score=“error”” to register NULL in the processing statement score (Step 807). By now, step 708 in FIG. 7 is completed.

A transition is made to next step 709, where NO is determined because the data item scores corresponding to the program line number “9” retrieved at step 808 are “error” and “1” in the data item score table (Step 709).

The data item score table is searched under the condition “program line number=program line number “9” retrieved at step 808” to retrieve data item scores “error” and “1” (step 702).

YES is determined (step 703) because “error” exists in the data item score retrieved at step 702.

At step 710, a calculation unit score “error” is retrieved (step 710). The processing statement information table is searched under the condition “program line number=program line number “9” retrieved at step 808” to register the “error” retrieved at step 710 in the calculation unit score (step 705).

The data item score table is searched under the condition “data item score=“error”” to register NULL in the data item score. (Step 706). By now, the process for calculating the calculation unit score at step 504 in FIG. 5 is completed.

A transition is made to next step 505, where YES is determined because the “error” exists in the calculation unit score of the processing statement information table (step 505).

At step 512, a processing statement score “error” is retrieved (step 512).

The processing statement information table is searched under the condition “program line number=program line number “9” retrieved at step 808” to register the “error” retrieved at step 512 in the processing statement score (Step 507).

The processing statement information table is searched under the condition “calculation unit score=“error”” to register NULL in the calculation unit score (Step 508).

The processing statement information table is searched under the condition “program line number=program line number “9” retrieved at step 808” to register NULL in the processing progress classification (Step 509).

In the process for calculating the processing statement score for the program line number 8, the processing at steps 810 onward is performed in a manner similar to the program line number 6.

YES is determined because the processing statement scores of all program line numbers are not NULL in the processing statement information table (Step 307).

After the task specification analysis process has been completed for the program under analysis, the task specification analysis result display unit (108) is initiated to first display a list of processing statement scores for processing statements, as shown in FIG. 33. As the operator enters a value in a processing statement score field 3301 and depresses an extraction button 3302, processing statements having values more than the entered processing statement score are displayed in a visually emphasized manner (FIG. 34). The operator executes a task specification analysis result display to display the task processing extraction result on a display device (Step 203).

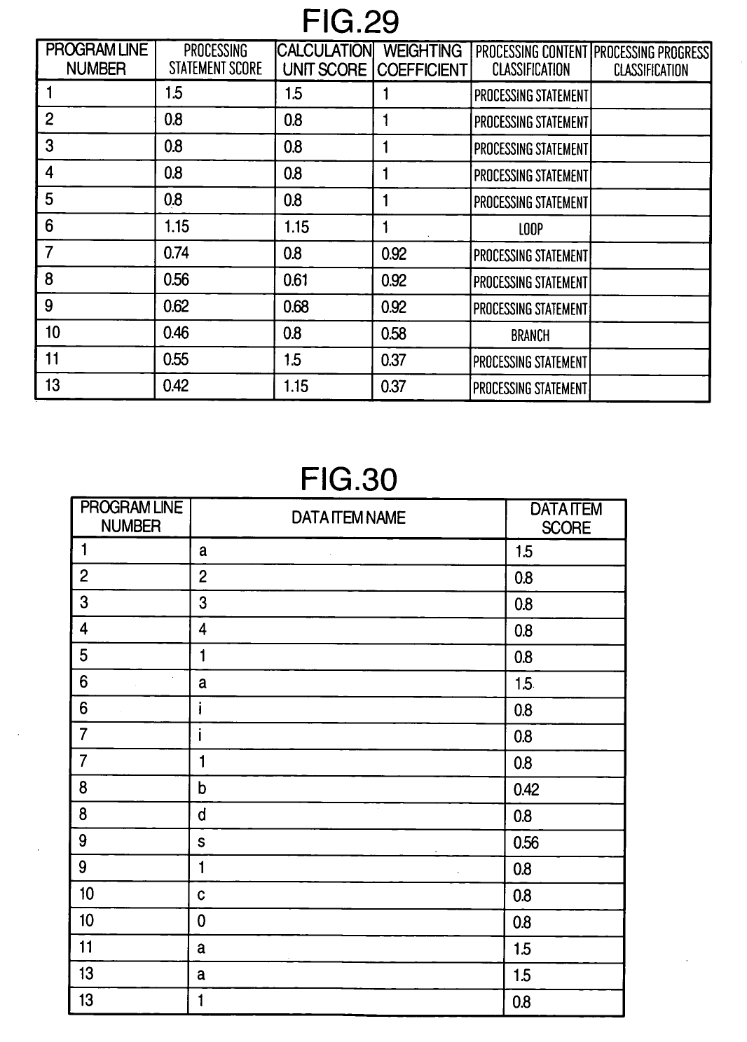

A final condition statement information table and data item score table, when the apparatus for analyzing task specifications is executed in this embodiment are shown in FIGS. 29 and 30, respectively.

The analysis of task specifications as described above evaluates the possibility of involvement in the task specifications, even if a data item of an instruction is an input, by classifying and setting a degree of involvement to the task in accordance with the type of the input, and reflecting a dependence relationship between processing statement of the program as elements of score calculation (processing contents).

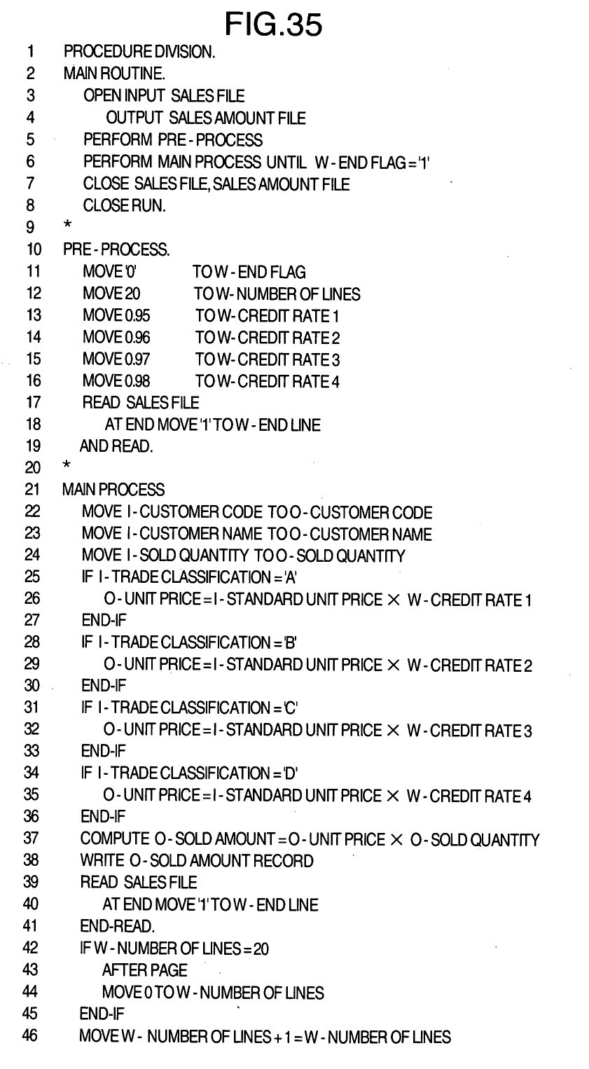

For verifying the effects of the apparatus for analyzing task specifications, a task-related program of FIG. 35 for receiving a sales file to create a sales amount file is used for a program under analysis. The program under analysis performs processing involved in a switching of a task called a calculation of a unit price according to a trading classification on program line numbers 25, 28, 31, 34. Also, processing not involved in a switching of the task is performed on a program line number 42, where an output file is fed to a next page.

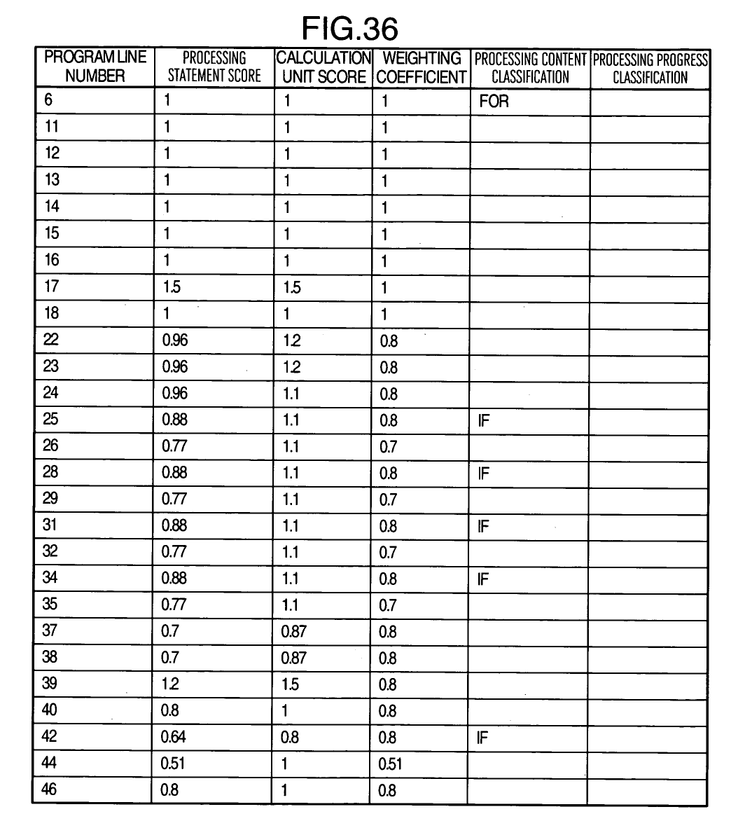

The result of the task specification analysis process on the program under analysis is registered in a processing statement information table of FIG. 36. It can be confirmed from FIG. 36 that processing statement scores of the program line numbers 25, 28, 31, 34 are all “0.88” and the processing statement score of the program line number 42 is “0.64”.

From the foregoing, the apparatus for analyzing task specifications can relatively compare processes involved in a switching of a task in regard to the processing statement scores to reference a processing statement which is highly likely to be involved in the switching of the task in accordance with the value of the processing statement score.

As described above, a task processing relation degree calculation apparatus presents a value indicative of the possibility that each of instructions in a program under analysis is involved in a switching of a task. The operator can preferentially confirm instructions having higher values, thereby efficiently understanding which processing is being performed in a program under analysis.

Finally, a deep consideration will be made on an optimal value for an input value of the apparatus for analyzing task specifications. In this embodiment, a value associated with an input value is defined to be in the following range:

(a) a value for an input which is involved in a switching of a task>>one or more;

(b) a value for a constant which is involved in a switching of a task>>less than one;

(c) a value indicative of the possibility that a control dependence target is involved in a switching of a task as compared with a control dependence source when the control dependence source is a branch process>>less than one; and

(d) a value indicative of the possibility that a control dependence target is involved in a switching of a task as compared with a control dependence source when the control dependence source is a loop process>>less than one.

Though not described in detail, in a task specification analysis on another program, (a) is set to “1.5”; (b) to “1”; (c) to “1”; and (d) to “1” (hereinafter called the “pattern 1”).

(1) Value of (a) is changed to “0.8”:

In an instruction involved in task specifications, the score is also lower when a data item is associated with a constant (in some cases, lower than an instruction which sets a constant to a data item). For this reason, when a processing content is confirmed from an instruction having a high score, a confirmation priority is lower than the pattern 1.

(2) Value of (c) is changed to “0.8”:

In an instruction involved in task specifications, an instruction at a deeper layer has a lower score as well when branch processes are layered. Accordingly, a similar result to (1) is shown. A similar result is shown for the value of (d) as well.

The pattern 1 is thought to be optimal for the values of (b), (c), (d) from (1), (2).

In regard to the value of (a), even a change in the value does not result in a change in a relative relationship of magnitude among scores of all instructions, so that the order at which instructions are confirmed remains unchanged. Accordingly, the pattern 1 may be applied to the value of (a) as well.

In conclusion, values associated with inputs should be the combination of the pattern 1.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. An apparatus for analyzing task specifications for supporting extraction of an instruction involved in a switching of a task from an inputted program under analysis, said apparatus comprising:
a task specification analysis unit which uses:
information for identifying whether an instruction of the program under analysis is a control statement or others;
information for identifying whether a data item in each instruction is a data item which references a value defined by another instruction, a data item having a value defined by the instruction, a data item which sets an input of the program in an instruction associated therewith, or a data item which is a constant;
information on a correspondence of a data dependence source to a data dependence target of a particular data item of each instruction, and information on a correspondence of a control dependence source to a control dependence target of a particular instruction;
a value indicative of how much an instruction of a control dependence target is less likely to be involved in a switching of a task as compared with an instruction of a control dependence source; and
a value indicative of the possibility of involvement in a switching of a task when a data item is a data item which sets an input of the program in an instruction associated therewith, or a data item which is a constant, and
outputs a task specification analysis result comprised of a pair of an instruction and a value indicative of the possibility that the instruction is involved in a switching of a task,
wherein when there are a certain first instruction and a different second instruction, the first instruction is a control statement when whether the second instruction should be executed or not is determined by the result of executing the first instruction; or
when there are a certain first instruction, a different second instruction, and a certain first data item, the first instruction is called a data dependence source of the first data item, and the second instruction is a data dependence target of the first data item when the first instruction defines the first data item, and when the second instruction references the first data item, and when there is no instruction which again defines the first data item while the second instruction is executed from the first instruction on a path on which the second instruction can be executed from the first instruction; or
when there are a certain first instruction and a different second instruction, the first instruction is called a control dependence source, and the second instruction is a control dependence target when whether the second instruction should be executed or not is determined by the result of executing the first instruction, and there is no instruction which determines whether or not the second instruction should be executed on a executable path from the first instruction to the second instruction.

2. An apparatus for analyzing task specifications for supporting extraction of an instruction involved in a switching of a task from an program under analysis, said apparatus comprising:
a task specification analysis unit which uses:
information for identifying whether a data item in each instruction is a data item which references a value defined by another instruction, a data item having a value defined by the instruction, a data item which sets an input of the program in an instruction associated therewith, or a data item which is a constant;
information on a correspondence of a data dependence source to a data dependence target of a particular data item of each instruction; and
a value indicative of the possibility of involvement in a switching of a task when a data item is a data item which sets an input of the program in an instruction associated therewith, or a data item which is a constant, and
outputs a task specification analysis result comprised of a pair of an instruction and a value indicative of the possibility that the instruction is involved in a switching of a task.

3. The apparatus for analyzing task specifications according to claim 1, wherein:
said task specification analysis unit replaces information indicative of an instruction which constitutes an input is a control statement or others with information indicative of whether an instruction is a control statement of a classification 1, a control statement of classification 2, or others,
replaces the value indicative of how much an instruction of a control dependence target is less likely to be involved in a switching of a task as compared with an instruction of a control dependence source, which constitutes an input, with a value indicative of how much the instruction of the control dependence target is less likely to be involved in the switching of the task as compared with the instruction of the control dependence source for each of cases where the instruction of the control dependence source is an instruction of the classification 1 and an instruction of the classification 2, when the instruction of the control dependence source is an instruction of the classification 1 and an instruction of the classification 2, and
does not replace a value indicative of the possibility that the instruction is involved in the switching of the task, which constitutes an output,
where when there are a certain first instruction and a different second instruction, the first instruction is a control statement of the first classification when whether or not the second instruction should be executed only once is determined by the result of executing the first instruction, or
when the instruction is a control statement, and when the instruction is not a control statement of the classification 1, the instruction is a control statement of the classification 2.

4. The apparatus for analyzing task specifications according to claim 1, wherein:
said task specification analysis unit replaces the information for identifying whether a data item in each instruction which constitutes an input is a data item which references a value defined by another instruction, a data item having a value defined by the instruction, a data item which sets an input of the program in an instruction associated therewith, or a data item which is a constant with information for identifying whether a data item in each instruction is a data item which references a value defined by another instruction, a data item having a data defined by the instruction, a data item which sets an input of the program in an instruction associated therewith, or a data item which is a constant, and
replaces the value indicative of the possibility of involvement in a switching of a task when a data item is a data item which sets an input of the program in an instruction associated therewith or a data item which is a constant, which constitutes an input, with a value indicative of the possibility that the data item is involved in a switching of a task when the data item is a data item which sets an input of the program in an instruction associated therewith, and is a data item is a constant, whereby a value indicative of the possibility that the instruction is involved in the switching of the task, which constitutes an output, differs depending on whether the data item is an input or is not an input.

5. The apparatus for analyzing task specifications according to claim 2, wherein:
said task specification analysis unit replaces the information for identifying whether a data item in each instruction which constitutes an input is a data item which references a value defined by another instruction, a data item having a value defined by the instruction, a data item which sets an input of the program in an instruction associated therewith, or a data item which is a constant with information for identifying whether a data item in each instruction is a data item which references a value defined by another instruction, a data item having a data defined by the instruction, a data item which sets an input of the program in an instruction associated therewith, or a data item which is a constant, and
replaces the value indicative of the possibility of involvement in a switching of a task when a data item is a data item which sets an input of the program in an instruction associated therewith, or a data item which is a constant, which constitutes an input, with a value indicative of the possibility that the data item is involved in a switching of a task when the data item is a data item which sets an input of the program in an instruction associated therewith, and is a data item is a constant, whereby a value indicative of the possibility that the instruction is involved in the switching of the task, which constitutes an output, differs depending on whether the data item is an input or is not an input.

6. The apparatus for analyzing task specifications according to claim 1, wherein:
said apparatus for analyzing task specifications further comprises a program analysis unit for receiving a program specified by a user to output information indicative of information for identifying whether an instruction of the program is a control statement or others, information for identifying whether a data item in each instruction is a data item which references a value defined by another instruction, a data item having a value defined by the instruction, a data item which sets an input of the program in an instruction associated therewith, or a data item which is a constant, information on a correspondence of a data dependence source to a data dependence target of a particular data item of each instruction, and information on a correspondence of a control dependence source to a control dependence target of a particular instruction.

7. The apparatus for analyzing task specifications according to claim 2, wherein:
said apparatus for analyzing task specifications further comprises a program analysis unit for receiving a program specified by a user to output information indicative of information for identifying whether an instruction of the program is a control statement or others, information for identifying whether a data item in each instruction is a data item which references a value defined by another instruction, a data item having a value defined by the instruction, a data item which sets an input of the program in an instruction associated therewith, or a data item which is a constant, information on a correspondence of a data dependence source to a data dependence target of a particular data item of each instruction, and information on a correspondence of a control dependence source to a control dependence target of a particular instruction.

8. The apparatus for analyzing task specifications according to claim 1, wherein:
said apparatus for analyzing task specifications further comprises a program analysis unit for receiving a program specified by a user to output information indicative of whether an instruction is a control statement of a classification 1, a control statement of classification 2, or others, a value indicative of how much the instruction of the control dependence target is less likely to be involved in the switching of the task as compared with the instruction of the control dependence source for each of cases where the instruction of the control dependence source is an instruction of the classification 1 and an instruction of the classification 2, when the instruction of the control dependence source is an instruction of the classification 1 and an instruction of the classification 2, information on a correspondence of a data dependence source to a data dependence target of a particular data item of each instruction, and information on a correspondence of a control dependence source to a control dependence target of a particular instruction.

9. The apparatus for analyzing task specifications according to claim 4, wherein:
said apparatus for analyzing task specifications further comprises a program analysis unit for receiving a program specified by a user to output information indicative of information for identifying whether an instruction of the program is a control statement or others, information for identifying whether a data item in each instruction is a data item which references a value defined by another instruction, a data item having a value defined by the instruction, a data item which sets an input of the program in an instruction associated therewith, or a data item which is a constant, information on a correspondence of a data dependence source to a data dependence target of a particular data item of each instruction, and information on a correspondence of a control dependence source to a control dependence target of a particular instruction.

10. The apparatus for analyzing task specifications according to claim 5, wherein:
said apparatus for analyzing task specifications further comprises a program analysis unit for receiving a program specified by a user to output information for identifying whether a data item in each instruction is a data item which references a value defined by another instruction, a data item having a value defined by the instruction, a data item which sets an input of the program in an instruction associated therewith, or a data item which is a constant, information on a correspondence of a data dependence source to a data dependence target of a particular data item of each instruction, and information on a correspondence of a control dependence source to a control dependence target of a particular instruction.

11. An apparatus for supporting extraction of an instruction which is likely to be involved in a switching of a task from a program specified by a user, wherein:
said apparatus receives a program specified by a user, and a value indicative of the possibility that a data item is involved in a switching of a task when the data item is a data item which sets an input of the program in an instruction associated therewith, and
outputs a task specification analysis result comprised of an instruction, and a value indicative of the possibility that the instruction is involved in a switching of a task.

12. An apparatus for supporting extraction of an instruction which is likely to be involved in a switching of a task from a program specified by a user, wherein:
said apparatus receives a program specified by a user, a value indicative of how much an instruction of a control dependence target is less likely to be involved in a switching of a task as compared with an instruction of a control dependence source and a value indicative of the possibility that a data item is involved in a switching of a task when the data item is a data item which sets an input of the program in an instruction associated therewith, and
outputs a task specification analysis result comprised of an instruction, and a value indicative of the possibility that the instruction is involved in a switching of a task.

13. The apparatus for analyzing task specifications according to claim 1, wherein:
a task processing condition extraction unit further comprising a task specification analysis result display unit for receiving a task specification analysis result comprised of an instruction, and a value indicative of the possibility that the instruction is involved in a switching of a task to display a correspondence of the instruction to the value indicative of the possibility that the instruction is involved in the switching of the task.

14. The apparatus for analyzing task specifications according to claim 1, wherein:
a task processing condition extraction unit further comprising a task specification analysis result display unit for receiving a task specification analysis result comprised of an instruction, and a value indicative of the possibility that the instruction is involved in a switching of a task to display instructions in an order in which the instructions presents higher values indicative of the possibility of the involvement in the switching of the task.

15. The apparatus for analyzing task specifications according to claim 1, wherein:
a task processing condition extraction unit further comprising a task specification analysis result display unit for receiving a task specification analysis result comprised of an instruction, and a value indicative of the possibility that the instruction is involved in a switching of a task to display instructions which has a certain value or more of the possibility that the instructions are involved in a switching of a task.

16. The apparatus for analyzing task specifications according to claim 1, wherein:
a task processing condition extraction unit further comprising a task specification analysis result display unit for receiving a task specification analysis result comprised of an instruction, and a value indicative of the possibility that the instruction is involved in a switching of a task to display a correspondence of an instruction which is a control statement to the value indicative of the possibility that the instruction is involved in the switching of the task.

17. An apparatus for analyzing task specifications for supporting extraction of an instruction involved in a switching of a task from a program under analysis, comprising a first memory for storing an analysis processing program, a second memory for storing the program under analysis and table information for use in an analysis process, an input device, an output device, and a processing unit for executing the analysis process to analyze the program under analysis,
wherein said analysis processing program comprises:
a program analysis process for reading the program under analysis and retrieving information (a), (b), (c), (d) for use in an analysis of specifications;
a task specification analysis process for receiving values (e), (f) from the input device to find a value which depends on a switching of a task for a processing statement which forms part of the program under analysis using the information (a), (b), (c), (d); and
a task specification analysis result display process for displaying a combination of the processing statement which forms part of the program under analysis with the value which depends on the switching of the task on the output means,
wherein said information (a) is information for identifying whether an instruction which forms part of the program under analysis is a control statement or another;
said information (b) is information for identifying whether a data item in each instruction which forms part of the program under analysis is a data item which references a value defined by another instruction, a data item having a value defined by the instruction, a data item which sets an input of the program in an instruction associated therewith, or a data item which is a constant;
said information (c) is information on a correspondence of a data dependence source to a data dependence target of a particular data item of each instruction;
said information (d) is information on a correspondence of a control dependence source to a control dependence target of a particular instruction;
said value (e) is a value indicative of how much an instruction of a control dependence target is less likely to be involved in a switching of a task as compared with an instruction of a control dependence source; and
said value (f) is a value indicative of the possibility of involvement in a switching of a task when a data item is a data item which sets an input of the program in an instruction associated therewith, or a data item which is a constant,

18. The apparatus for analyzing task specifications according to claim 17, wherein:
said task specification analysis process finds a weighting coefficient and a calculation unit score for a processing statement which forms part of the program under analysis; and
the product of the weighting coefficient and the calculation unit score is a value which depends on the switching of the task.

19. The apparatus for analyzing task specifications according to claim 17, wherein said value (e) is a value equal to or less than one.

20. The apparatus for analyzing task specifications according to claim 17, wherein said value (f) is a value equal to or more than one when a data item sets an input of a program in an instruction associated therewith.

21. The apparatus for analyzing task specifications according to claim 18, wherein a constant is set to said weighting coefficient when there is no control dependence source program line of the processing statement which is being processed.
